(19) United States
(12) Patent Application Publication
(10) Pub. No.: US 2010/0206408 A1
(43) Pub. Date: Aug. 19, 2010

(54) MATERIAL TRANSFER SYSTEM

(76) Inventor: Kenneth P. Krohn, Carlsbad, CA (US)

Correspondence Address: LAW OFFICE OF KENNETH P. KROHN,;A PROFESSIONAL LAW CORPORATION, POST OFFICE BOX 4415, CARLSBAD, CA, 92018, US

(21) Appl. No.: 12/705,611

(22) Filed: Feb. 14, 2010

Related U.S. Application Data
(60) Provisional application No. 61/152,958, filed on Feb. 16, 2009.

(51) Int. Cl. F15D 1/00

(52) U.S. Cl. 137/602

(57) ABSTRACT

The present invention discloses a device for transferring fluids to a duct (such as pipe, tubing or a container spout) that may have a size and configuration that are adapted to be variable within a predetermined range. Thus, the device may act as a funnel that can be connected to containers having spouts with a variety of different sizes and thread designs. The device generally comprises a fluid directing member (such as a funnel) and a duct support assembly that is deflected radially outward from the duct and exerts a force radially inward against the duct, which assists in holding the duct in place relative to the device. The device may also have a modular feature that allows interchangeable duct support assemblies and/or a flow control mechanism to regulate the flow of fluid into the duct. The invention also includes certain kits and methods of using the device.

### CROSS REFERENCES TO OTHER APPLICATIONS

This application claims the benefit of U.S. provisional application No. 61/152,958 filed on Feb. 16, 2009, which provisional application is incorporated herein by reference.

### BACKGROUND

The present invention generally relates to a device that may be used to transfer fluids to a duct (such as a length of pipe or tubing or a container spout), as well as kits and methods of use related to the device. More specifically, the device may be used to transfer fluids to ducts having different sizes and characteristics. In a preferred embodiment, the device is comprised of a funnel-type receptacle and a mechanism that holds the receiving container operatively in place relative to the receptacle, where the container's spout has an open end size and configuration that may be variable within a given range. Thus, the device may be used to transfer the contents of one container to a variety of other containers having spouts of different sizes and configurations without spillage.

There are material transfer systems known in the relevant art that are comprised of a funnel-type of mechanism that may be used to transfer fluids from one container to another. These systems are often inconvenient to use or are limited to use with a single size of container spout. For example, the smaller outlet of a standard funnel is typically positioned within the spout of the container to which fluids are to be transferred. If there are no means present to hold the container in place relative to the funnel, use of the funnel may be difficult because one hand may be needed to hold the receiving container, another to hold the funnel, and yet another to hold the transferring container.

As a result, means have been developed for holding the receiving container in place relative to the funnel. For example, some holding means assist in holding the funnel in place by a telescoping or other variable diameter member that is placed inside the container spout. These types of systems often suffer from the same instability that is present in standard funnels because the narrower neck and wider brim of the funnel present a higher free-energy state that may have a tendency to tip a narrow container from the vertical position. Other holding means include a structure that is positioned between the funnel and the container and rests on the spout. These means also often suffer from a similar type of instability. Still other means include a connector at the outlet of the funnel that is rigidly connected to the spout of the container, so that the funnel and the container act as an integrated unit. Although these means are often more stable, they are often limited in that they may be connected to container spouts having only one size and thread configuration. Yet other means include a torsional clamping mechanism to hold the container in place relative to the funnel. These means, however, may be impractical for smaller sizes of container spouts. They may also be limited in the range of spout sizes they can practically accommodate. Further, they may suffer from instability because the clamping mechanism is positioned on one side of the funnel.

Therefore, there is a need for a device that has a funnel-type receptacle and a holding mechanism that holds a container in place relative to the receptacle, where the holding mechanism can accommodate containers having a spout with a variety of different sizes and configurations (such as thread designs). There is also a need for the holding mechanism to have characteristics that provide increased stability of the receptacle/container system to prevent tipping of the container. This stability may be provided, for example, where the holding mechanism moves radially relative to the spout and holds the spout in place by exerting a force radially inward against the spout. It may also be advantageous to have a holding mechanism that is deflected by the spout as the container is connected to the device in order to make for simpler operation. In such cases, the user of the device may simply push the device onto the container spout. Further, it may be advantageous in certain circumstances for the holding mechanism to have a modular character so that it is interchangeable with other mechanisms to accommodate an even broader variety of container spouts. Further still, there is a need for the device to be simple to use, easy to clean, and inexpensive to manufacture. It may also be advantageous for the device to include a mechanism to control the flow of the fluid through the device into the container.

A material transfer device having these features would be advantageous over other devices and methods that are not as flexible with respect to the variety of ducts (such as container spouts) that may be connected. It would also be more advantageous over other methods and devices that are less stable, more difficult to use, and more prone to spillage of the transferred fluid.

### SUMMARY

The present invention is directed to a device and system, as well as related kits and methods of using the device and system, which meet the needs discussed above in the Background section. As described in greater detail below, the present invention, when used for its intended purposes, has many advantages over other devices known in the art, as well as novel features that result in a new device, kits and methods of using the device that are not anticipated, rendered obvious, suggested, or even implied by any prior art devices or methods, either alone or in any combination thereof.

In a preferred embodiment of the present invention, a device is disclosed that is adapted for transferring a fluid into a duct (such as a spout on a container). The device is comprised of a receptacle and duct support means for operatively holding the duct in place relative to the receptacle, which means are described in more detail below. The receptacle is adapted to receive the fluid and direct the fluid through a receptacle outlet into the duct. The duct support means are adapted to be deflected longitudinally and radially outward by the duct as the duct is operatively connected to the receptacle and exert a radially inward force against the duct. Preferably, the duct has a duct open end adapted to receive the fluid and is adapted to have a variety of different sizes and characteristics within a predetermined range. The duct support means are adapted to operatively hold ducts having a size and characteristics within the predetermined range. The device may further comprise a shell member extending from the receptacle, and the duct support means may be positioned adjacent to the shell member. The device may also comprise support assembly connecting means for connecting the duct support means to the shell member. The duct support means may also be comprised of a plurality of duct support members, where each of the duct support members is comprised of a connector portion extending approximately longitudinally away from the receptacle, and a duct engaging portion extending from the connector portion in the approximate direction of the longitudinal axis of the device. In these embodiments, there are preferably at least three duct support members and no more than ten duct support members.

In another embodiment, a device adapted to transfer fluid to the open end of a duct is comprised of a receptacle having a receptacle outlet through which the fluid is adapted to be transferred into the duct, and a plurality of duct support members extending from the receptacle and adapted to operatively hold the duct in place relative to the receptacle. In this embodiment, the duct support members are adapted to deflect radially outward from the duct and exert a radially inward force against the duct. Each of the plurality of duct support members may comprise a connector portion extending away from the receptacle, and an engaging portion extending from the connector portion approximately toward the longitudinal axis of the device. In some of these embodiments, the connector portion is adapted to deflect radially outward from the duct. Each of the engaging portions may be comprised of a resilient material, and a portion of the engaging portion may extend from the connector portion in the approximate direction of the longitudinal axis of the device and toward the receptacle. In other embodiments, the engaging portion is adapted to deflect longitudinally and radially outward from the duct. At least one of the engaging portions may be further comprised of a thread tab portion. Or, each of the engaging portions may be further comprised of a plurality of thread tab portions. The device may also further comprise pivoting connecting means for pivotally connecting the engaging portion to the connecting portion. The pivoting connecting means may also be further comprised of a spring mechanism that causes the engaging portion to be forced against the duct while the duct is operatively connected to the device.

In yet another embodiment, a device for transferring fluid into a duct comprises a fluid directing member comprising a receptacle having a receptacle outlet through which the fluid is adapted to be transferred to the duct. In this embodiment, a duct support assembly is adapted to be positioned adjacent to the device, and is adapted to deflect longitudinally and radially outward from the duct and hold the duct operatively in place relative to the fluid directing member by exerting a radially inward force against the duct. The device may further comprise the duct support assembly or duct support assembly connecting means for permanently or removably connecting the duct support assembly to the fluid directing member, or the device may comprise both. In still another embodiment, a device adapted to assist in the transfer of fluid to a duct by means of a fluid directing member comprising a receptacle is comprised of a duct support assembly adapted to operatively hold the duct in place relative to the fluid directing member. The receptacle is adapted to receive the fluid and has a receptacle outlet through which the fluid is adapted to be transferred to an open end of the duct. A portion of the duct support assembly is adapted to deflect longitudinally and radially outward from the duct and exert a radially inward force against the duct. This device may also further comprise the fluid directing member or duct support assembly connecting means for permanently or removably connecting the support assembly to the fluid directing member, or the device may comprise both. A kit may be comprised of the duct support assembly and the fluid directing member.

In a further embodiment, a device for transferring fluid to a duct is comprised of a receptacle having a receptacle outlet, a shell member extending from the receptacle, duct support means adapted for operatively connecting the duct to the device, a securing cap, and cap connecting means for operatively connecting the securing cap to the shell member. A portion of the duct support means are adapted to deform longitudinally and radially outward from the duct and exert a radially inward force against the duct. A portion of the duct support means may be positioned between the securing cap and the shell member. A kit may be comprised of this device and a second duct support means adapted for operatively connecting a duct to the device. A method of using this device comprises: (a) either positioning the duct support means adjacent to the shell member, or positioning the duct support means adjacent to the securing cap; and (b) connecting the securing cap to the shell member using the cap connecting means.

In another embodiment, a device for transferring fluid to a duct is comprised of a receptacle having a receptacle outlet, a shell member extending from the receptacle, a connector support member positioned adjacent to the shell member, and a plurality of engaging support members extending from the connector support member into the interior space of the shell member. The engaging support members are adapted to hold the duct in operational alignment with the receptacle outlet while the duct is operatively connected to the device. The engaging support members are also adapted to deform longitudinally and radially outward from the duct and exert a radially inward force against the duct. Each of the engaging support members may be comprised of a resilient material, and a portion of the engaging support member may extend in an arc from the connector support member in the approximate direction of the axis of the device and the receptacle.

In each case, the duct may generally be adapted to have a variety of different sizes and configurations within a predetermined range, and the device is adapted to be operatively connected to ducts having a size and configurations within the predetermined range. In addition, the above described devices may typically further comprise flow control means for regulating the flow of fluid materials from the receptacle into the duct. They may also typically have a receptacle that further comprises a receptacle inlet adapted to be operatively connected to a second duct, so that the fluid is adapted to be transferred from the second duct through the receptacle inlet into the receptacle. Further, where the above described devices have a hollow receptacle having a receptacle inlet that is larger than the receptacle outlet, the device may further comprise an interior receptacle having an interior receptacle outlet. The interior receptacle is adapted to be positioned within the receptacle, preferably so that the interior receptacle outlet is approximately adjacent to the receptacle outlet.

Therefore, the material transfer system and device of the present invention meets the requirements described above in the Background section. The device may have a funnel-type receptacle and a duct support assembly that holds a container in place relative to the receptacle. The duct support assembly can accommodate containers having a spout with a variety of different sizes and configurations (such as thread designs). The duct support assembly also provides increased stability of the receptacle/container system to prevent tipping of the container. This stability is provided, in part, because the duct support assembly moves radially relative to the spout and holds the spout in place by exerting a force radially inward against the spout. Further, the duct support assembly of the device may be deflected by the spout as the container is connected to the device in order to make for simpler operation. The user of the device may simply push the device onto the container spout. In some embodiments, the duct support assembly may have a modular character so that different sizes and configurations of duct support assemblies are interchangeable with various types of receptacles and fluid directing members. This system can accommodate an even broader variety of container spouts. In yet other embodiments, the device may include a flow control mechanism to regulate the flow of fluid through the device into the container. The device has a simple, easy to use and reuse design that allows its connection to ducts having multiple sizes, thread types, or material compositions. In addition, ducts may be quickly and easily connected to, and then removed from, the device. The device may also be simpler to manufacture than other duct connecting means. The device may also be easily disassembled and reassembled for purposes of cleaning the device. The device therefore possesses features that make it advantageous over other devices and methods that are not as flexible with respect to the variety of ducts (such as containers and their spouts) that may be connected to the device.

There has thus been outlined, rather broadly, the more primary features of some embodiments of the present invention. There are additional features that are also included in the various embodiments of the invention that are described hereinafter and that form the subject matter of the claims appended hereto. In this respect, it is to be understood that the invention is not limited in its application to the details of construction and to the arrangements of the components set forth in the following description or illustrated in the following drawings. This invention may be embodied in the form illustrated in the accompanying drawings, but the drawings are illustrative only and changes may be made in the specific construction illustrated and described within the scope of the appended claims. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

The foregoing summary, as well as the following description, will be better understood when read in conjunction with the appended drawings, in which:

FIG. 1 is an exploded perspective view of an embodiment of a device of the present invention, as viewed from the side of and above the device.

FIG. 2 is an elevation view of the embodiment of the device illustrated in FIG. 1, as viewed from above the receptacle of the device.

FIG. 3 is an exploded sectional view of the embodiment of the device illustrated in FIG. 1 and FIG. 2, as taken along the lines 3-3 in FIG. 2.

FIG. 4 is a sectional view of the embodiment of the device illustrated in FIG. 1 through FIG. 3, as taken along the line 3-3 in FIG. 2, and illustrating a container with a larger spout connected to the device.

FIG. 5 is an exploded perspective view of another embodiment of a device of the present invention, as viewed from the side of and above the device.

FIG. 6 is an elevation view of the embodiment of the device illustrated in FIG. 5, as viewed from above the receptacle of the device.

FIG. 7 is a sectional view of the embodiment of the device illustrated in FIG. 5 and FIG. 6, as taken along the lines 7-7 in FIG. 6.

FIG. 8 is an exploded perspective view of yet another embodiment of a device of the present invention, as viewed from the side of and above the device.

FIG. 9 is an elevation view of the embodiment of the device illustrated in FIG. 8, as viewed from above the receptacle of the device.

FIG. 10 is a sectional view of the embodiment of the device illustrated in FIG. 8 and FIG. 9, as taken along the lines 10-10 in FIG. 9.

FIG. 11 is an exploded perspective view of still another embodiment of a device of the present invention, as viewed from the side of and above the device.

FIG. 12 is an elevation view of the embodiment of the device illustrated in FIG. 11, as viewed from above the receptacle of the device.

FIG. 13 is a sectional view of the embodiment of the device illustrated in FIG. 11 and FIG. 12, as taken along the lines 13-13 in FIG. 12.

FIG. 14 is a partially exploded perspective view of another embodiment of a device of the present invention, as viewed from the side of and above the device.

FIG. 15 is an elevation view of the embodiment of the device illustrated in FIG. 14, as viewed from above the receptacle of the device.

FIG. 16 is an enlarged sectional view of the embodiment of the device illustrated in FIG. 14 and FIG. 15, as taken along the lines 16-16 in FIG. 15.

FIG. 17 is an enlarged perspective view of the duct support means of the embodiment of the device illustrated in FIG. 14 through FIG. 16, as viewed from the side of and above the duct support means as it is operatively connected to a spout on a container.

FIG. 18 is a partially exploded perspective view of another embodiment of a device of the present invention, as viewed from the side of and above the device.

FIG. 19 is an enlarged perspective view of the duct support means of the embodiment of the device illustrated in FIG. 18, as viewed from the side of and above the duct support means.

FIG. 20 is a partially exploded perspective view of still another embodiment of a device of the present invention, as viewed from the side of and above the device.

FIG. 21 is an elevation view of the embodiment of the device illustrated in FIG. 20, as viewed from above the duct support means of the device.

FIG. 22 is a partially exploded sectional view of the embodiment of the device illustrated in FIG. 20 and FIG. 21, as taken along the lines 22-22 in FIG. 21.

FIG. 23 is a perspective view of another embodiment of a device of the present invention, as viewed from the side of and above the duct support means of the device.

FIG. 24 is a perspective view of the embodiment of the device illustrated in FIG. 23, as viewed from the side of and above the receptacle of the device.

FIG. 25 is a perspective view of yet another embodiment of a device of the present invention, as viewed from the side of and above the device.

FIG. 26 is a perspective view of the embodiment of the device illustrated in FIG. 25, as viewed from the side of and below the device.

FIG. 27 is a perspective view of the embodiment of the device illustrated in FIG. 25 and

FIG. 26, as viewed from the side of and above the device as it is operatively connected to a spout on a container.

FIG. 28 is an exploded perspective view of still another embodiment of a device of the present invention, as viewed from the side of and below the device.

FIG. 29 is an elevation view of the embodiment of the device illustrated in FIG. 28, as viewed from above the duct support means of the device.

FIG. 30 is a sectional view of the embodiment of the device illustrated in FIG. 28 and FIG. 29, as taken along the lines 30-30 in FIG. 29.

### DETAILED DESCRIPTION

Reference will now be made in detail to the preferred aspects, versions and embodiments of the present invention, examples of which are illustrated in the accompanying drawings. While the invention will be described in conjunction with the preferred aspects, versions and embodiments, it is to be noted that the aspects, versions and embodiments are not intended to limit the invention to those aspects, versions and embodiments. On the contrary, the invention is intended to cover alternatives, modifications, portions and equivalents, which may be included within the spirit and scope of the invention as defined by the appended claims.

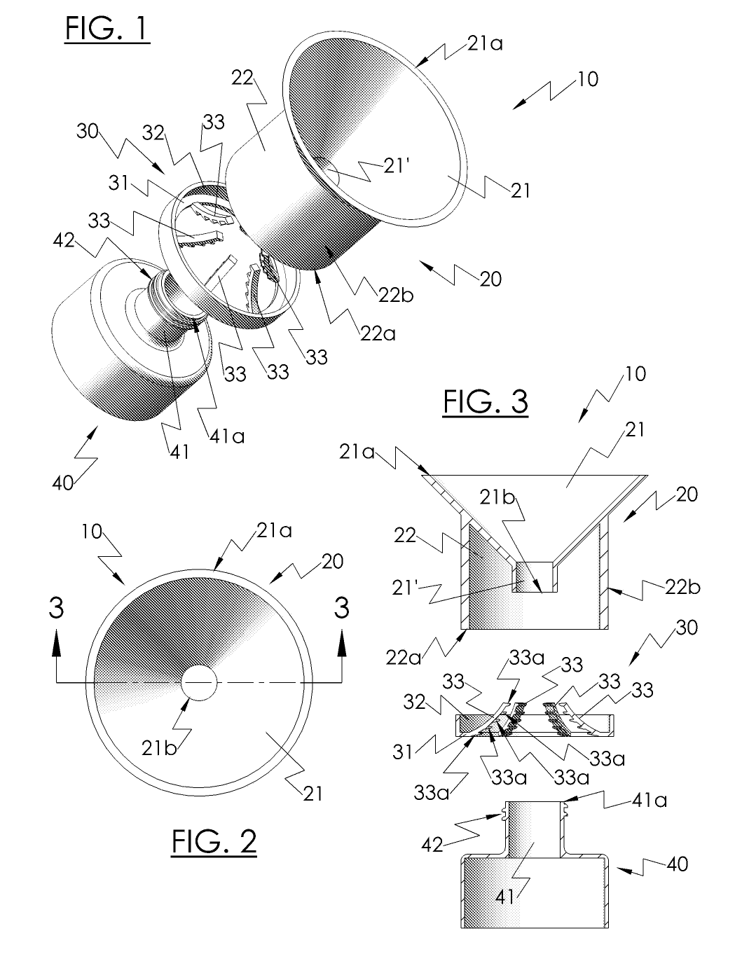

One embodiment of the present invention is illustrated in FIG. 1 through FIG. 4, which portray a device 10 for transferring fluid (not illustrated) into a duct (spouts 41, 41′ on containers 40, 40′ in this embodiment) with an open end 41a, 41a′ adapted to receive the fluid. It is to be noted that the “fluid” may comprise liquids, as well as other materials that may flow in a manner similar to liquids. For example, “fluids” may include powders (such as baking soda and talcum powder) and granular solids (such as sand), as well as viscous and non-viscous liquids. The ducts (spouts 41, 41′ in this embodiment) that may be operatively connected to the device 10 may be comprised in whole or in part of conduit, tubing (including medical or food grade tubing), pipeline, duct, hose, channel, vent or other similar objects. The ducts (spouts 41, 41′) may also comprise a spout or other outlet or inlet member of a bottle, canister, can, cask, box, bag, carton, carafe, hopper, pouch, package, packet, sack, vial, flask, jar, jug, tank, vat, vessel or other container. It is anticipated, however, that the ducts (spouts 41, 41′) will typically be comprised of a spout (such as spouts 41, 41′) on a container (such as containers 40, 40′) that the user of the device 10 desires to fill with fluid. The ducts (spouts 41, 41′) preferably have a tubular shape, as illustrated in FIG. 1, but they may have other shapes in other embodiments. The ducts (spouts 41, 41′), as well as the containers 40, 40′, may also be comprised of any materials suitable for constructing ducts (spouts 41, 41′) and containers 40, 40′. Examples include metals, polymers (such as polyvinyl chloride (PVC), polyethylene, acrylonitrile butadiene styrene (ABS), rubber, synthetic rubber (including NEOPRENE), silicon, and other polymers), wood, glass, fiberglass, carbon-based and other composites, or other materials or a combination of such materials. Further, the ducts (spouts 41, 41′) may have a variety of different configurations, such as different thread types (threads 42, 42′ on the spouts 41, 41′ in the illustrated embodiment) on the exterior surface thereof. Alternatively, the ducts (spouts 41, 41′) may have no threads or a different type of means (such as one or more grooves or ridges or other geometrical features) that permit the duct (spouts 41, 41′) to be connected to a cap (not illustrated) that is adapted to cover the duct (spouts 41, 41′) and the duct open end. It is to be noted that references herein to the variable nature of the duct (spouts 41, 41′) with respect to size and characteristics is generally meant to refer to the portion of the duct (spouts 41, 41′) adjacent to the duct open end 41a, 41a′ that is intended to be operatively connected to the device 10. Other portions of the duct (spouts 41, 41′ and possibly containers 40, 40′) may have other shapes and characteristics.

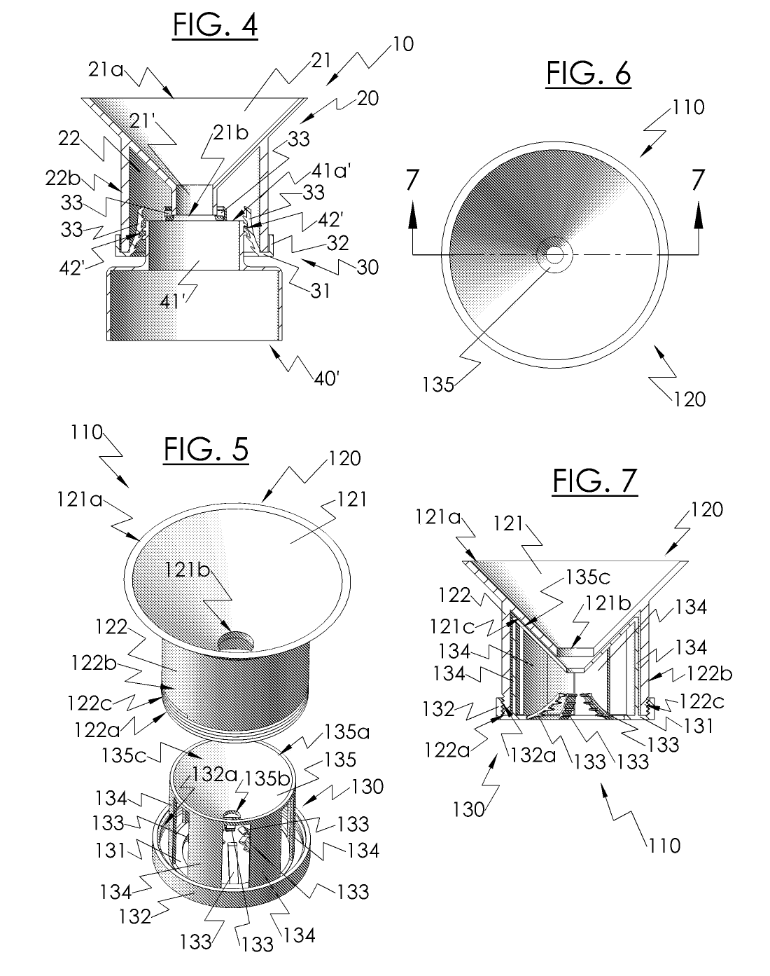

The device 10 illustrated in FIG. 1 is comprised of fluid directing means (fluid directing mechanism 20, which is further comprised of a receptacle 21 and a shell member 22 in this embodiment), duct support means (duct support assembly 30 in this embodiment), and duct support assembly connecting means for connecting the fluid directing means to the duct support means, all as described in more detail below. The fluid directing means (fluid directing mechanism 20) are adapted to receive the fluid and direct the fluid through a receptacle outlet 21b into the duct (spout 41), and consequently into the container 40, as described in more detail below. The duct support means (duct support assembly 30) are adapted to operatively hold the duct (spout 41) in place relative to the receptacle 21, as described in more detail below. In this embodiment, the duct support means (duct support assembly 30) are adapted to be deflected longitudinally and radially outward by the duct (spout 41) as the duct (spout 41) is operatively connected to the device 10 and to exert a radially inward force against the duct (spout 41), all as described in more detail below. Thus, as best illustrated by comparing FIG. 3 with FIG. 4, the duct (spout 41) is inserted (and may also be rotated as it is inserted) into the duct support means (duct support assembly 30, as described in more detail below) when the user of the device 10 desires to connect the container 40, 40′ to the device 10. As the duct (spout 41′) is inserted into the device 10, a plurality of duct support members 33 that comprise the duct support assembly 30 and extend in the approximate direction of the longitudinal axis of the device 20, are deflected radially outward and longitudinally toward the receptacle 21 by the duct (spout 41) as the duct (spout 41) is moved into position relative to the device 10, as described in more detail below. As best illustrated in FIG. 3, each of the duct support members 33 is further comprised of a plurality of thread tab portions 33a that are adapted to engage any threads 42, 42′ or other geometrical features that may be present on the duct (spout 41), as described in more detail below. By engaging the threads 42, 42′, the thread tab portions 33a may assist in operatively connecting the device 10 to the duct (spout 41). It is to be noted that the thread tab portions 33a are only designated by identity numbers on one duct support member 33 in FIG. 3, and not at all in FIG. 1, FIG. 2 and FIG. 4, in order to simplify the drawings, but that all similar portions illustrated in all of the drawings are to be considered thread tab portions 33a as well. While the duct (spout 41) is held operatively in position relative to the device 10, the duct support members 33 exert force radially inward against the duct (spout 41), operatively connecting the duct (spout 41) and the container 40 to the device 10. Preferably, the duct open end 41a is adapted to receive the fluid and the duct (which comprises a portion of the spout 41 adjacent to the duct open end 41a intended to be connected to the device 10) may have a variety of different sizes and configurations within a predetermined range. The duct support means are adapted to operatively hold ducts (such as spouts 41, 41′) having a size and characteristics (such as threads 42) within the predetermined range, as described in more detail below. Each of the components comprising the device 10, as well as operation of the device 10, is now described in more detail.

As illustrated in FIG. 1 through FIG. 4, the device 10 is comprised of fluid directing means (fluid directing mechanism 20) adapted to receive the fluid and direct the fluid into the duct (spout 41). In this embodiment, the fluid directing means (fluid directing mechanism 20) are comprised of a receptacle 21 and a shell member 22 that extends approximately longitudinally from the receptacle 21. Also in this embodiment, the receptacle 21 has a receptacle inlet 21a and a receptacle outlet 21b, which is smaller than the receptacle inlet 21a. Further, in this embodiment, the receptacle 21 is comprised of an outlet extension 21′, which may or may not be adapted to extend into the duct (spout 41) open end while the duct (spout 41) is operatively connected to the device 10. The receptacle 21 is adapted to receive the fluid to be transferred to the container 40. In this embodiment, the fluid may be transferred to the receptacle 21 by pouring the fluid from another duct (such as a pipe, tube or hose) or another container (all not illustrated) through the receptacle inlet 21a into the interior space of the receptacle 20. The fluid collected in the receptacle 21 is then directed through the receptacle outlet 21b into the duct (spout 41). Thus, the receptacle 21 may act in a manner similar to a funnel, directing fluid poured from another container into the container 40. The receptacle 21 illustrated in FIG. 1 through FIG. 4 is generally shaped as a funnel. That is, it is approximately frusto-conical in shape and has an outlet extension 21′ positioned at the receptacle outlet 21b. In this embodiment, the extension 21′ is adapted to extend into the open end of the duct (spout 41) while the duct (spout 41) is operatively connected to the device 10 in order to reduce the possibility of spillage of the fluid as it is transferred from the receptacle 21 to the duct (spout 41). In other embodiments, the outlet extension 21′ may be longer or shorter, may have a different shape than illustrated, or may have a different orientation relative to the other portions of the receptacle 21, or any combination thereof. Preferably, the receptacle outlet 21b is smaller than the duct open end 41a, 41a′ for all ducts that are within the range of sizes of ducts (spout 41, 41′) that may be operatively connected to the device 10 in order to minimize spillage of fluid as it is transferred from the receptacle 21 to the duct (spout 41). In still other embodiments, however, the receptacle 21 may not have an outlet extension 21′.

In the embodiment of the device 10 illustrated in FIG. 1 through FIG. 4, the shell member 22 extends approximately longitudinally from the receptacle 21. By extending “approximately longitudinally” from the receptacle 21, it is meant that either the longitudinal axis or the sidewall (or possibly sidewalls in other embodiments) of the shell member 22 is generally parallel to the longitudinal axis of the device 10, but that the longitudinal axis or sidewall of the shell member 22 may deviate from being parallel as long as the deviation does not materially adversely affect operation of the device 10. The longitudinal axis of the device 10 is generally defined by a line passing through the center of the receptacle outlet 21b and the center of the open end of the duct (spout 41) while the duct (spout 41) is operatively connected to the device 10. Thus, the shell member 22 generally extends parallel to the longitudinal axis of the device 10 in this embodiment. As an example of an acceptable deviation from parallel, the shell member 22 may have a frusto-conical shape with a larger opening at its distal end 22a (where it meets the duct support assembly 30 in this embodiment), so that the sidewall of the shell member 22 is not parallel to the axis of the device 10, but that the distal end 22a of the shell member 22 is such that the duct support assembly 30 is still positioned relative to the receptacle 21 so that the device 10 functions as intended. In this embodiment, the distal end of the shell member 22 has a shape and orientation that enables it to be operatively connected to the duct support means (duct support assembly 30) using the support assembly connecting means, as described in more detail below.

Preferably, the receptacle 21 and the shell member 22 are comprised of a suitable rigid or semi-rigid material so that they are rigid enough to hold the fluid directed into the duct (spout 41) and to operatively support the duct support means (duct support assembly 30) while the duct (spout 41) is operatively connected to the device 10. For example, the receptacle 21 and the shell member 22 may be comprised of metal (such as steel, steel alloys, aluminum, copper, brass, or other metals or metal alloys), polymers (such as PVC, polyethylene, polypropylene, ABS, and other polymers), wood, fiberglass, carbon-based or other composites, or other materials or a combination of such materials. Referring to the device 10 as an example, the preferred material is dependent upon a number of different factors, such as the anticipated size, shape and type of the duct (spout 41), the type of duct support means (duct support assembly 30) to be utilized, the anticipated operating temperatures of the device 10, the type of fluid to be transferred to the duct (spout 41), the desired wall thickness and weight of the receptacle 21 and the shell member 22, the preferences of the user of the device 10, and other factors. Although the receptacle 21 and the shell member 22 are preferably constructed of the same material, they need not always be constructed of the same material. The receptacle 21 and the shell member 22 may be fabricated using any suitable means. For example, a receptacle 21 and shell member 22 constructed of PVC may be formed by injection molding, and a receptacle 21 and shell member 22 constructed of a metal alloy may be formed by metal injection molding or possibly metal stamping. The receptacle 21 and the shell member 22 may be connected together by any appropriate means, such as a threaded connection, clasps, clamps, clips, pins, hinges, adhesives, adhesive tapes, epoxies, welding, fusing, nails, screws, nuts, bolts, or other types of fasteners or connectors, either alone or in conjunction with one another in different combinations. Alternatively, the receptacle 21 and the shell member 22 may be fabricated together as a single integrated unit.

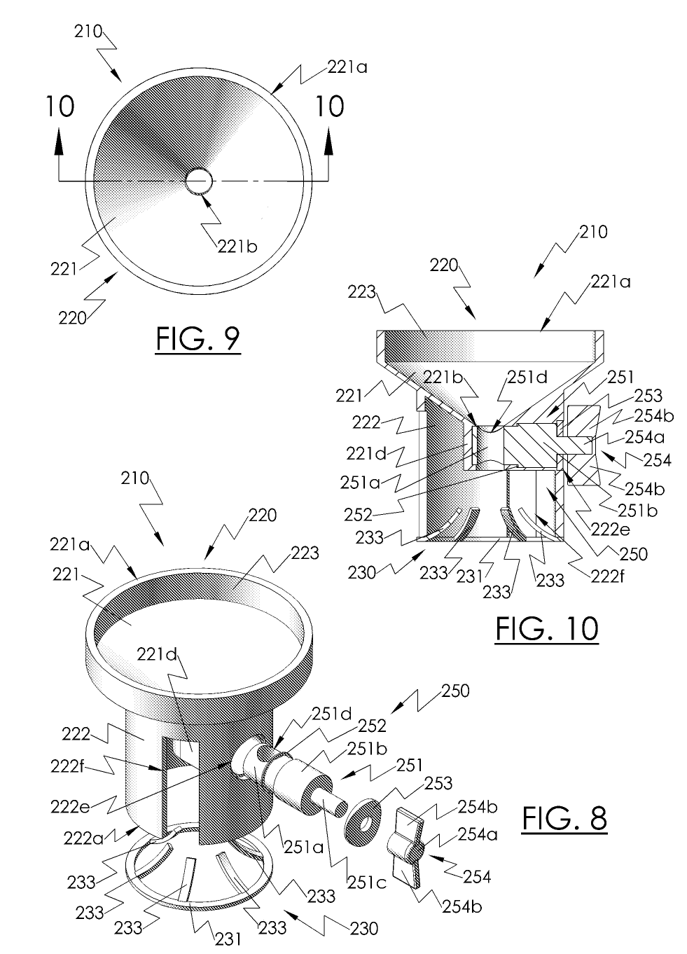

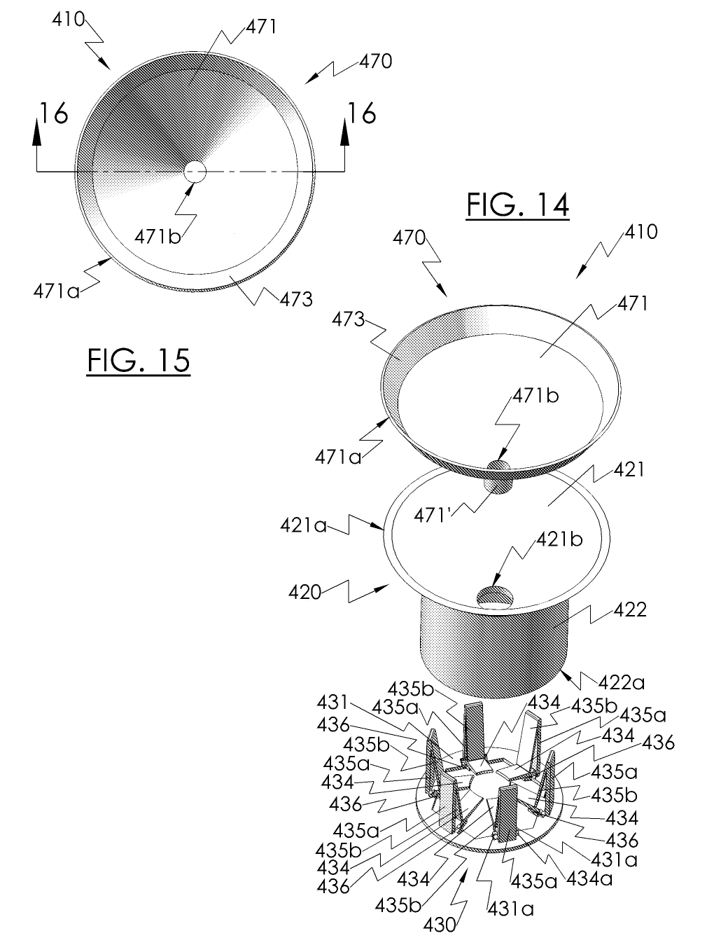

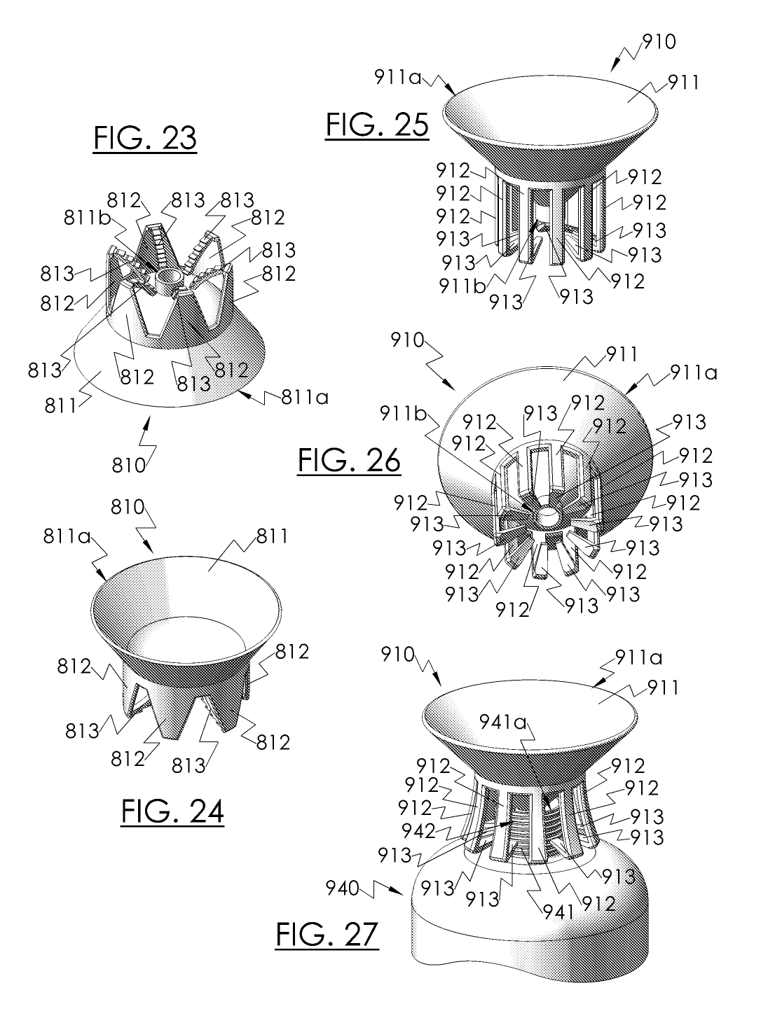

It is to be noted that the fluid directing means (fluid directing mechanism 20) may have different shapes, orientations, features, structures, operation and other characteristics in other embodiments of the present invention. For example, the receptacle 21 may have a different shape, structure, features and characteristics. Thus, as illustrated in FIG. 8 through FIG. 10, the receptacle 221 may further comprise a rim 223 positioned at the receptacle inlet 21a to help reduce spillage of the fluid. As illustrated by the interior receptacle 470 of FIG. 14 through FIG. 16, the rim 473 may also have a different shape and orientation. As illustrated in FIG. 9 through FIG. 13, the receptacle 221, 321 may also have a shape, especially at its receptacle outlet 221b, 321b, which permits the receptacle 221, 321 to accommodate flow control means 250, 360, which are described in more detail below. In these embodiments, the fluid directing means (fluid directing mechanism 20) may also comprise the flow control means 250, 360. As illustrated in FIG. 23 and FIG. 24, the receptacle 811 may have a shape that is spherical adjacent to the receptacle outlet 811b. As other examples, and referring again to FIG. 1 through FIG. 4 for reference, the receptacle 21 may be approximately elliptical, triangular, square, rectangular, pentagonal, another polygonal shape, other shapes having arcuate or linear portions, or another shape or combination of such shapes, when viewed from almost any perspective, as long as the fluid directing means (fluid directing mechanism 20) cooperates with the duct support means (duct support assembly 30) in operation of the device 10 and adequately performs its function of receiving the fluid and directing the fluid through the receptacle outlet 21b into the duct (spout 41). Similarly, the shell member 22 may have a different shape, structure, features and characteristics. For example, the shell member 22 may be frusto-conical in shape.

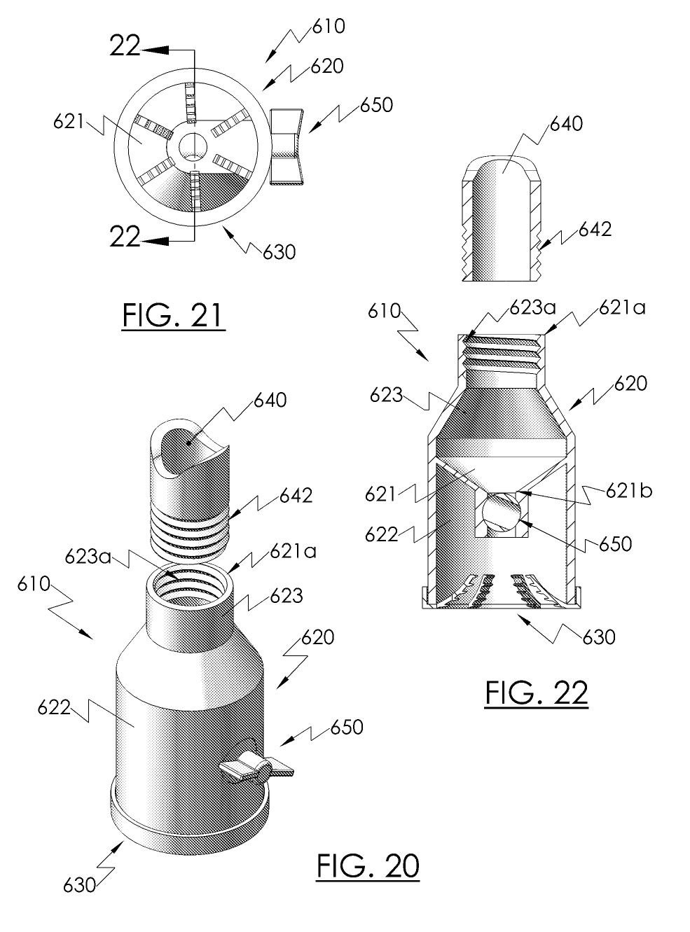

As another example, rather than being tubular in shape, the shell member 22 may have a cross-sectional shape that is approximately elliptical, triangular, square, rectangular, pentagonal, another polygonal shape, other shapes having arcuate or linear portions, or another shape or combination of such shapes, as long as the fluid directing means (fluid directing mechanism 20) cooperate with the duct support means (duct support assembly 30) in operation of the device 10 and adequately perform their function of receiving the fluid and directing the fluid through the receptacle outlet 21b into the duct (spout 41). As still another example, as illustrated in FIG. 8, the shell member 222 may have openings 222f therein, which may be used for the purpose of viewing the connection of the duct (spout 41) to the device 10 to ensure that the connection is operative. In these embodiments, the openings 222f may have almost any shape or orientation and there may be any number of them as long as they do not adversely affect the operation of the device 10, as described in more detail below. In still other embodiments, the fluid directing means (fluid directing mechanism 20) may have still other features. For example, as illustrated in FIG. 20 through FIG. 22, the receptacle 621 may also comprise a connecting extension 623, which permits the fluid directing means 620 to be rigidly connected to another duct 640, as described in more detail below. In yet other embodiments, as illustrated in FIG. 14 through FIG. 16, the fluid directing means may further comprise an interior receptacle 470 adapted to be positioned within the receptacle 421, as described in more detail below. Further still, as illustrated in FIG. 5 through FIG. 7, the fluid directing means may further comprise a second fluid directing means for directing the fluid into the duct (spout 41, 41′), which means are a part of the duct support assembly 130 and are further comprised of a support shell member 134 and a support receptacle 135 in the illustrated embodiment, all as described in more detail below. In addition, and referring again to FIG. 1 through FIG. 4 for reference, the fluid directing means (fluid directing mechanism 20) may form a seal with the duct (spout 41, 41′). This may be the case, for example, where the open end 41a, 41a′ of the duct (spout 41, 41′) is positioned adjacent to the receptacle 21 while the duct (spout 41, 41′) is operatively connected to the device 10. There need not, however, be a seal between the receptacle 21 and the duct (spout 41, 41′) in all embodiments. Further, the fluid directing means (fluid directing mechanism 20) may incorporate monitoring devices, such as flow meters, temperature sensors, pressure sensors, material composition sensors, alarms, and other devices, monitors and mechanisms. Further still, the fluid directing means may include only the receptacle 21 and not the shell member 22 in some embodiments, in which case the shell member 22 may comprise a part of the duct support means (duct support assembly 30). In addition, the fluid directing means may comprise indica, which may be used to indicate the level of fluid present in the fluid directing means. For example, as illustrated in FIG. 9 through FIG. 13, where the receptacle 221, 321 comprises flow control means 250, 360, which are described in more detail below and originally in the “closed” position, the receptacle 221, 321 may have markings thereon the indicate the level of fluid present in the receptacle 221, 321, so that the user may pour a given amount of fluid into the receptacle 221, 321 by observing the markings and then open the flow control means 250 so that the given amount of fluid is transferred to the container (not illustrated).

In the device 10 illustrated in FIG. 1 through FIG. 4, the duct support means are comprised of the duct support assembly 30. In this embodiment, the duct support assembly 30 is further comprised of connecting member 31, 32 and duct engaging members 33. Also in this embodiment, the connecting member 31, 32 is further comprised of a connecting flange portion 31 and a connecting sidewall portion 32 that protrudes from the connecting flange portion 31. Further, in this embodiment, the connecting member 31, 32 is positioned adjacent to the shell member 22, so that the connecting flange portion 31 is adjacent to the distal end 22a of the shell member 22 and the connecting sidewall portion 32 is adjacent to the exterior surface 22b of the sidewall of the shell member 22. Although this is the preferred orientation in this embodiment, the orientation of the connecting member 31, 32 relative to the shell member 22 may be different in other embodiments. For example, the connecting sidewall portion 32 may not always be positioned adjacent to the sidewall portion of the shell member 22, and the connecting flange portion 31 may not always be positioned adjacent to the distal end 22a of the shell member 22. In the illustrated embodiment, the connecting member 31, 32 is approximately annular in shape, which allows it to cooperate with the shell member 22. In other embodiments, the connecting member 31, 32 may have a different shape. For example, as illustrated in FIG. 8 and FIG. 10, the connecting member 231 may not have a sidewall portion. As another example, as illustrated in FIG. 14 through FIG. 17, the connecting member 431 may have a hexagonal interior shape. As other examples, and referring again to FIG. 1 through FIG. 4 for reference, the connecting member 31, 32 may be approximately elliptical, triangular, square, rectangular, pentagonal, another polygonal shape, other shapes having arcuate or linear portions, or another shape or combination of such shapes, when viewed from almost any perspective, as long as the connecting member 31, 32 cooperates with the fluid directing means (receptacle 21 and shell member 22) in operation of the device 10 and adequately performs its function of operatively supporting the duct engaging members 33 in a manner that permits the duct engaging members 33 to perform their intended function, as described in more detail below.

In this embodiment, the duct engaging members 33 extend in an arc from the connecting member 31, 32 toward the longitudinal axis of the device 10 and toward the receptacle 21, as illustrated in FIG. 1 through FIG. 4. (As described above, the longitudinal axis of the device 10 is generally defined by a line passing through the center of the receptacle outlet 21b and the center of the open end 41a of the duct (spout 41) while the duct (spout 41) is operatively connected to the device 10.) It is to be noted that by “extend toward the longitudinal axis of the device 10,” the duct engaging members 33 extend in the general direction of, and not necessarily directly toward, the longitudinal axis of the device 10. In other embodiments, the duct engaging members 33 may extend in an arc from the connecting member 31, 32 toward the longitudinal axis of the shell member 22 and toward the receptacle 21 or into the interior space of the shell member 22. In various embodiments, the arc formed by the duct engaging members 33 may have a greater or smaller radius than illustrated in FIG. 1 through FIG. 4, the duct engaging members 33 may have a greater or lesser length, the duct engaging members 33 may not have a uniform width along their length, only a portion of the duct engaging members 33 may be arcuate while part is linear, or one or more of the duct engaging members 33 may have a different shape and orientation as compared to other duct engaging members 33, or any combination of the same. In the illustrated embodiment, the duct engaging members 33 extend from the interior edge of the connecting flange portion 31. In other embodiments, the duct engaging members 33 may extend from any other portion of the connecting member 31, 32 or even from the shell member 22 or the receptacle 21 (or a combination thereof). Although the duct engaging members 33 are preferably uniformly and symetrically spaced around the connecting member 31, 32, the duct engaging members 33 may not be so spaced in other embodiments. Further, there are six duct engaging members 33 in this embodiment. In other embodiments, there may be more or fewer duct engaging members 33. Preferably, there are at least three duct engaging members 33 and no more than ten duct engaging members 33. Also in this embodiment, the duct engaging members 33 further comprise a plurality of thread tab portions 33a, which are typically adapted to engage any threads (such as threads 42, 42′) or possibly other geometrical features present on the exterior surface of the duct (spout 41, 41′). By engaging the threads 42, 42′, the thread tab portions 33a may assist in operatively holding the duct (spout 41, 41′) in place relative to the device 10. Preferably, at least one of the duct engaging members 33 comprises a plurality of thread tab portions 33a. More preferably, each of the duct engaging members 33 has a plurality of thread tab portions 33a. The thread tab portions 33a may be spaced uniformly along the duct engaging members 33 and have the same shape, spacing, arrangement and orientation on all of the duct engaging members 33. In other embodiments, one or more of the duct engaging members 33 may not have any thread tab portions 33a, may have fewer or more thread tab portions 33a than other duct engaging members 33, or may have a different shape, spacing, arrangement or orientation of thread tab portions 33a as compared with other duct engaging members 33, or any combination thereof. For example, the duct engaging members 33 may each have the same orientation of thread tab portions 33a, but the thread tab portions 33a of each of the duct engaging members 33 may be slightly displaced longitudinally from the thread tab portions 33a of other duct engaging members 33 in progression around the circumference of the connecting member 31, 32 in order to better accommodate ducts (spouts 41, 41′) having threads 42, 42′. In the illustrated embodiment, there are five thread tab portions 33a on each duct engaging member 33, but in other embodiments there may be fewer or more thread tab portions 33a depending upon the anticipated use of the device 10 and the desires of the user of the device 10.

Preferably, the duct support assembly 30 is comprised of a suitable rigid or semi-rigid material. More preferred, the duct engaging members 33 are also comprised of a resilient material, so that they are adapted to deform as the duct (spout 41, 41′) is operatively connected to the device 10 and exert a force radially inward against the duct (spout 41, 41′) while the duct (spout 41, 41′) is operatively connected to the device 10. For example, the connecting member 31, 32 and the duct engaging members 33 may be comprised of metal (such as steel, steel alloys, aluminum, copper, brass, or other metals or metal alloys), polymers (such as PVC, polyethylene, polypropylene, ABS, and other polymers), wood, fiberglass, carbon-based or other composites, or other materials or a combination of such materials. Referring to the device 10 as an example, the preferred material is dependent upon a number of different factors, such as the anticipated size, shape and type of the duct (spout 41), the type of fluid directing means 20 to be utilized, the anticipated operating temperatures of the device 10, the type of fluid to be transferred to the duct (spout 41), the desired wall thickness and weight of the device 10, the preferences of the user of the device 10, and other factors. Although the connecting member 31, 32 and the duct engaging members 33 are preferably constructed of the same material, they need not always be constructed of the same material. The duct support assembly 30 may be fabricated using any suitable means. For example, a duct support assembly 30 constructed of PVC may be formed by injection molding, and a duct support assembly 30 constructed of a metal alloy may be formed by metal injection molding. The connecting member 31, 32 and the duct engaging members 33 may be connected together by any appropriate means, such as a threaded connection, clasps, clamps, clips, pins, hinges, adhesives, adhesive tapes, epoxies, welding, fusing, nails, screws, nuts, bolts, or other types of fasteners or connectors, either alone or in conjunction with one another in different combinations. Alternatively, and preferably, the connecting member 31, 32 and the duct engaging members 33 may be fabricated together as a single integrated unit.

As is best illustrated by comparing the device 10 of FIG. 3 with the device 10 of FIG. 4 as it is connected to the duct (spout 41′), the duct support means (and duct engaging members 33 in particular in this embodiment) are adapted to be deflected longitudinally and radially outward by the duct (spout 41, 41′) as the duct (spout 41, 41′) is operatively connected to the device 10. The duct support means (and duct engaging members 33 in particular in this embodiment) are “deflected longitudinally” in the sense that they are deflected in part approximately along the longitudinal axis of the device 10 generally toward the receptacle 21, as illustrated in FIG. 4. The duct support means (and duct engaging members 33 in particular in this embodiment) are “deflected radially outward” in the sense that they are deflected in part radially away from the longitudinal axis of the duct (spout 41, 41′), as illustrated in FIG. 4. Thus, as the duct (spout 41, 41′) is operatively connected to the device 10, the duct (spout 41, 41′) is inserted into the device 10 so that the open end 41a, 41a′ of the duct (spout 41, 41′) engages the duct engaging members 33. As the duct (spout 41, 41′) is advanced into the device 10, the duct (spout 41, 41′) causes the duct engaging members 33 to deflect longitudinally and radially outward. Once the duct (spout 41, 41′) is operatively in place in the device 10, which means that the duct (spout 41, 41′) is in the position relative to the receptacle 21 desired by the user of the device 10 so that fluids may be transferred through the receptacle outlet 21b into the duct (spout 41, 41′), the duct engaging members 33 exert a force radially inward against the duct (spout 41, 41′). It is to be noted that the device 10 (and the duct support assembly 30 in particular) is capable of being operatively connected to ducts (spout 41, 41′) having a variety of different sizes and configurations (such as thread 42, 42′ designs) within a predetermined range, which gives the device 10 an advantage over other apparatus currently known in the relevant art.

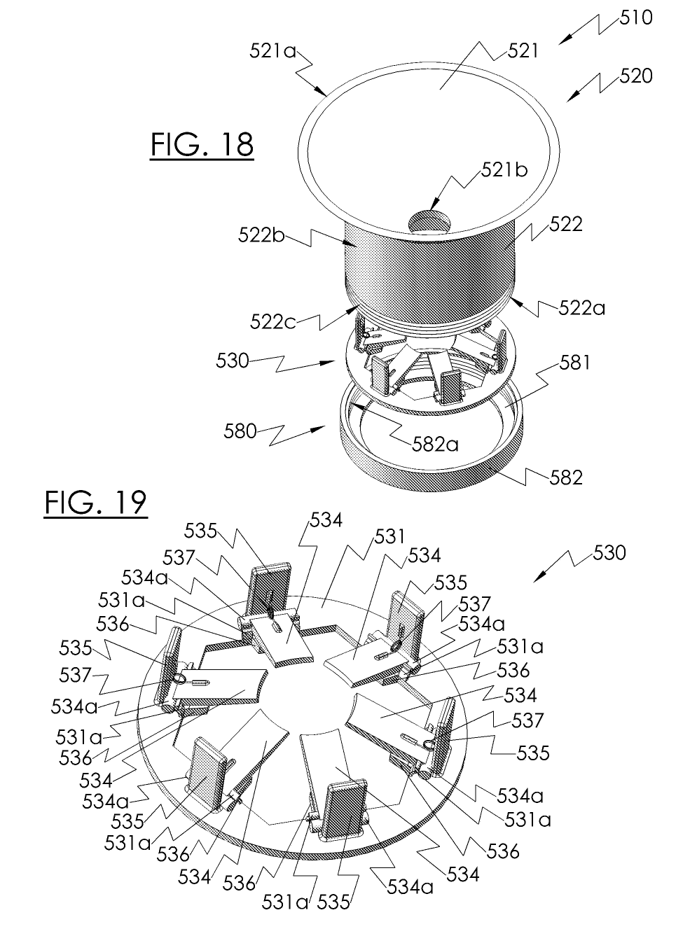

When the user of the device 10 desires to remove the container 40, 40′ from the device 10, a force is exerted on the container 40 tending to pull the container 40 from the device 10 while the container 40 is rotated in a manner that causes the threads 42, 42′ to be disengaged from the thread tab members 33a while the duct (spout 41, 41′) is displaced outward from the device 10 approximately along the longitudinal axis of the device 10. It is to be noted that the duct (spout 41, 41′) need not deflect the duct support means (duct support assembly 30) as the duct (spout 41, 41′) is operatively connected to the device 10 in all embodiments. For example, as illustrated in FIG. 18 and FIG. 19, the support assembly 530 may have a mechanism (not illustrated) that allows the duct engaging members 534 to be deflected prior to insertion of the duct (not illustrated) into the device 510, such as by a mechanism that allows the user of the device 510 to deflect the duct engaging members 534 independent of the position of the duct. In this case, the duct engaging members 534 may be deflected first, the duct may then be inserted into the device 510, and the duct engaging members 534 may then be released to exert a radially inward force against the duct in order to hold the duct operatively in place relative to the device 510, all as described in more detail below.

Referring again to the device 10 illustrated in FIG. 1 through FIG. 4 for reference, it is to be noted that the duct support means (duct support assembly 30) may have different shapes, orientations, features, structures, operation and other characteristics in other embodiments of the present invention. For example, as described above, the duct support assembly 30 may have a different shape, structure, features, orientations and characteristics. In addition, as illustrated in FIG. 5 through FIG. 7, the connecting member 131, 132 may further comprise threads 132a that cooperate with threads 122c on the shell member 122, and the duct support assembly 130 may further comprise additional fluid directing means for directing the fluid into the duct (spout 41, 41′), which means are further comprised of a second shell member 134 and a second receptacle 135 in the illustrated embodiment, all as described in more detail below. As illustrated by the duct support assembly 230 of FIG. 8 through FIG. 10, there may not be any thread tab portions comprising the duct engaging members 233. In addition, and referring again to FIG. 1 through FIG. 4 for reference, the various portions and members comprising the support assembly 30 may have a different configuration. For example, the duct engaging members 33 may extend from the shell member 22. Further, the duct support assembly 30 may be positioned adjacent to the interior surface of the shell member 22 rather than at the distal end 22a or on the exterior surface of the shell member 22. As another example, all or a portion of the duct support assembly 30 may be positioned adjacent to the receptacle 21, as is the case with the devices 810, 910 illustrated in FIG. 23 through FIG. 27, as described in more detail below. As yet another example, the duct support means may comprise a different type of mechanism. One such mechanism is the duct support assembly 430 illustrated in FIG. 14 through FIG. 17, which is described in more detail below in connection with such figures. Another such mechanism is the duct support assembly 530 illustrated in FIG. 18 and FIG. 19, which is described in more detail below in connection with such figures. Still another such mechanism is the duct support assembly 1030 illustrated in FIG. 28 through FIG. 30, which is described in more detail below in connection with such figures. Further still, and referring again to the device 10 illustrated in FIG. 1 through FIG. 4 for reference, the duct support means may further comprise a flow control mechanism. In addition, the duct support means may comprise a plurality of engaging support members, such as duct engaging members 33, extending from a connector support member, such as connecting member 31, 32, into the interior space of the shell member 22, wherein the engaging support members are adapted to hold the duct (spouts 41, 41′) in operational alignment with the receptacle outlet 21b while the duct (spouts 41, 41′) is operatively connected to the device 10.

Referring to the device 10 illustrated in FIG. 1 through FIG. 4, the support assembly connecting means are used to removably or permanently connect the fluid directing means 20 (fluid directing mechanism 20 and shell member 22 in particular in this embodiment) to the duct support means (duct support assembly 30 in this embodiment). For example, support assembly connecting means that may be used to removably connect the fluid directing means (fluid directing mechanism 20) to the duct support means (duct support assembly 30) comprise clasps, clamps, clips, pins, hinges, other pivoting connectors or other types of connectors, either alone or in conjunction with one another in different combinations. As another example, the shell member 22 may have a groove (not illustrated) extending around the circumference of its exterior surface 22b near the distal end 22a of the shell member 22, and the connecting sidewall portion 32 may have a circumferential ridge extending around its interior surface that cooperates with the shell member groove to hold the duct support assembly 30 operatively in place relative to the shell member 22. The groove and ridge may also be reversed, so that the groove is positioned on the connecting sidewall portion 32 and the ridge is positioned on the shell member 22. Examples of support assembly connecting means that may be used to permanently connect the fluid directing means (fluid directing mechanism 20) to the duct support means (duct support assembly 30) include adhesives, epoxies, welding, fusing, nails, screws, nuts, bolts, or other fasteners or a combination of such means. The fluid directing means (fluid directing mechanism 20) and the duct support means (duct support assembly 30) may also be fabricated together as a single integrated unit. In addition, as illustrated in FIG. 5 through FIG. 7, where portions of the fluid directing means (fluid directing mechanism 20) and the duct support means (duct support assembly 30) are approximately cylindrical in shape, the support assembly connecting means may be comprised of threads 122c on the exterior surface 122b of the shell member 122 adjacent to the distal end 122a of the shell member 122 and corresponding threads 132a on the interior surface of the connecting sidewall portion 132 of the duct support assembly 130. Thus, the duct support assembly 130 may be placed over the distal end 122a of the shell member 122, and may then be screwed down onto the shell member 122. It is to be noted that the support assembly connecting means may also comprise a threaded connection having a different configuration, as is the case with the device 510 illustrated in FIG. 18, as described in more detail below. In addition, the support assembly connecting means may comprise yet other configurations, as is the case with the device 1010 illustrated in FIG. 28 through FIG. 30, as described in more detail below. Referring again to the device 10 illustrated in FIG. 1 through FIG. 4 for reference, the preferred characteristics of the support assembly connecting means are dependent upon a number of different factors, such as the anticipated range of configurations and sizes of the duct (spout 41), the materials comprising and the shape of the shell member 22 and the duct support assembly 30, the desire that the device 10 have a modular capability (as described in more detail below), the preferences of the user of the device 10, and other factors. A method of constructing or using the device 10 is also disclosed, the method comprising connecting the fluid directing means (fluid directing mechanism 20) to the duct support means (duct support assembly 30) utilizing the support assembly connecting means.

Another embodiment of the present invention is the device 110 illustrated in FIG. 5 through FIG. 7. In this embodiment, the device 110 is comprised of fluid directing means (fluid directing mechanism 120, which is further comprised of receptacle 121 and shell member 122 in this embodiment), duct support means (duct support assembly 130 in this embodiment), and support assembly connecting means (threads 122c, 132a in this embodiment). Except as specifically noted below, the fluid directing means (receptacle 121 and shell member 122) of the device 110 may comprise substantially any of the same structure, features, characteristics, functions and operation as the fluid directing means (receptacle 21 and shell member 22) described in more detail above and illustrated in connection with FIG. 1 through FIG. 4. In addition, and except as specifically noted below, the duct support means (duct support assembly 130) of the device 110 may comprise substantially any of the same structure, features, characteristics, functions and operation as the duct support means (duct support assembly 30) described in more detail above and illustrated in connection with FIG. 1 through FIG. 4. Further, and except as specifically noted below, the support assembly connecting means of the device 110 may comprise substantially any of the same structure, features, characteristics, functions and operation as the support assembly connecting means described in more detail above and illustrated in connection with FIG. 1 through FIG. 4.

In the device 110 illustrated in FIG. 5 through FIG. 7, the duct support assembly 130 is comprised of a connecting member 131, 132, a second shell member 134, and a second receptacle 135. The connecting member 131, 132 is further comprised of a connecting flange portion 131 and a connecting sidewall portion 132. The connecting sidewall portion 132 has threads 132a on its interior surface that cooperate with threads 122c present on the exterior surface 122b of the shell member 122. Thus, the support assembly connecting means are comprised of the cooperating threads 132a, 122c, which allow the duct support assembly 130 to be removably connected to the shell member 122 by screwing the duct support member 130 onto shell member 122 at its distal end 122a. The duct support assembly 130 may be removed from the shell member 122 by unscrewing the duct assembly 130 from the shell member 122. This feature allows the user of the device 110 to use various fluid directing means (receptacle 121 and shell member 122) interchangeably with various duct support means (duct support assembly 130). For example, the receptacle 121 and the shell member 122 of this embodiment are substantially the same in shape as the receptacle 21 and shell member 22, respectively, of device 10 (described in detail above and illustrated in FIG. 1 through FIG. 4), except for the threads 122c present on the shell member 122. Similarly, the interior surface of the connecting sidewall portion 32 of the duct support assembly 30 is substantially the same as the connecting sidewall portion 132 of the duct support assembly 130, except for the threads 132a present on the connecting sidewall portion 132. Thus, if the duct support assembly 30 of device 10 were to have similar threads (not illustrated) on the interior surface of the connecting sidewall portion 32, the duct support assembly 30 would be interchangeable with the duct support assembly 130 of device 110, so that the user of the device 110 could connect the shell member 122 to either the duct support assembly 30 or the duct support assembly 130. The duct support assembly 30 of device 10 has substantially the same type of duct engaging members 33 as the duct engaging members 133 of the duct support assembly 130, except that the duct support assembly 30 of device 10 is adapted to be operatively connected to ducts (spouts 41, 41′) generally having a range of sizes that is larger than the range of duct sizes that can be operatively connected to the duct support assembly 130 of device 110. Thus, this type of modular system permits the user of the device 110 to quickly and easily adapt the device 110 to accommodate different size ranges of ducts (not illustrated) that may be operatively connected to the device 110 by interchanging different sizes of duct support assemblies 30, 130. Substantially any type of fluid directing means, duct support means, and removable support assembly connecting means may be utilized in combination in this type of modular system.

In this type of modular system, as represented by the device 110 illustrated in FIG. 5 through FIG. 7, there may be cases where the receptacle outlet 121b is adapted for use with a range of larger duct sizes. Use of the receptacle 121 with a duct support assembly 130 adapted to be used with a range of smaller duct sizes may be problematic because the receptacle outlet 121b is too large, causing spillage because the fluid is directed not just into the duct open end, but outside it as well. Thus, the duct support assembly 130 may comprise a second fluid directing means (second shell member 134 and second receptacle 135 in this embodiment) to assist in directing the fluid to the smaller range of ducts. Except as specifically required to accommodate its use (e.g., to cooperate with the device 110 in terms of geometry and orientation), the second fluid directing means (second receptacle 135 and shell member 135 in this embodiment) of the device 110 may comprise substantially any of the same structure, features, characteristics, functions and operation as the fluid directing means (receptacle 21 and shell member 22) described in more detail above and illustrated in connection with FIG. 1 through FIG. 4. The second fluid directing means (second shell member 134 and second receptacle 135) operate in substantially the same manner as the fluid directing means (receptacle 121 and shell member 122), except that the second receptacle outlet 135b is smaller than the receptacle outlet 121b to direct the fluid into the smaller ducts. Preferably, the second receptacle outlet 135b is positioned so that its center is on the longitudinal axis of the device 110, which positions it approximately in line with the receptacle outlet 121b and duct open end (not illustrated). In addition, and although it need not be the case in every embodiment, it is preferred that the geometry of the receptacle 121 and the second receptacle 135 is such that at least a portion of the receptacle 121 and the second receptacle 135 are positioned adjacent to one another forming a seal or partial seal between them to reduce the possibility of spillage of fluid during use of the device 110.

Another embodiment of the present invention is the device 210 illustrated in FIG. 8 through FIG. 10. In this embodiment, the device 210 is comprised of fluid directing means (fluid directing mechanism 220, which is further comprised of receptacle 221, which further comprises a rim 223, and shell member 222 in this embodiment), flow control means (flow control mechanism 250 in this embodiment), duct support means (duct support assembly 230 in this embodiment), and support assembly connecting means. Except as specifically noted below, the duct support means (duct support assembly 230) of the device 210 may comprise substantially any of the same structure, features, characteristics, functions and operation as the duct support means (duct support assembly 30, 130) described in more detail above and illustrated in connection with FIG. 1 through FIG. 7. In addition, and except as specifically noted below, the support assembly connecting means of the device 210 may comprise substantially any of the same structure, features, characteristics, functions and operation as the support assembly connecting means described in more detail above and illustrated in connection with FIG. 1 through FIG. 7. Further, and except as specifically noted below, the fluid directing means (receptacle 221, 223 and shell member 222 in this embodiment) of the device 210 may comprise substantially any of the same structure, features, characteristics, functions and operation as the fluid directing means (receptacle 21, 121 and shell member 22, 122) described in more detail above and illustrated in connection with FIG. 1 through FIG. 7. It is to be noted that the shell member 222 in this embodiment has shell openings 222f that permit the user of the device 210 to view the interior of the device 210 to be sure it is operating properly. In other embodiments, the shell openings 222f may be larger or smaller, may extend a greater or lesser length along the shell member 222, may have a different shape, and may have a different orientation (e.g., spiral along the shell member 222 rather than extend longitudinally). There may also be more or fewer shell openings 222f, depending upon the desire of the user of the device 210.

In the device 210 illustrated in FIG. 8 through FIG. 10, the fluid directing means (fluid directing mechanism 220, which is further comprised of receptacle 221, 223 and shell member 222 in this embodiment) further comprise a valve extension member 221d that extends from around the receptacle outlet 221b to the shell member 222. A shell opening 222e extends from the exterior surface 222b of the shell member 222 into the valve extension member 221d through the receptacle 221 adjacent to the receptacle outlet 221b. The flow control means (flow control mechanism 250 in this embodiment) is comprised of a valve shaft 251, a valve seal 252, a valve cover plate 253, and a valve handle 254. The valve shaft 251 is positioned within and extends into the shell opening 222e. A first portion 251a of the valve shaft 251 is positioned so that it extends across the receptacle 221 adjacent to the receptacle outlet 221b. A second portion 251b of the valve shaft 251 is larger than the first portion 251a, so that the valve seal 252 can be positioned between a portion of the valve extension member 221d and the second portion 251b to form a seal that prevents fluid from flowing along the valve shaft 251 and leaking from the device 210. The valve seal 252 is comprised of a washer, gasket, o-ring or similar structure constructed of a suitable sealing material, such as rubber (including NEOPRENE). A third portion 251c of the valve shaft 251 extends through the valve cover plate 253, which is adapted to hold the valve shaft 251 in place relative to the shell member 222. The perimeter portion of the valve cover plate 253 is removably or permanently attached to the adjacent portion of the shell member 222 using any suitable means, which may be similar to any of the support assembly connecting means described in more detail above and illustrated in connection with FIG. 1 through FIG. 7. The valve handle 254 is further comprised of a hub 254a, which is rigidly connected to the third portion 251c of the valve shaft 251, and handles 254b. The valve shaft 251 also has a fluid opening 251d that is preferably positioned concentrically with the receptacle outlet 221b. In operation, the user of the device 210 may stop the flow of fluids through the receptacle outlet 221b into the duct (not illustrated) by turning the valve handle 254 until the axis of the fluid opening 521d is approximately perpendicular to the axis of the receptacle 221 adjacent to the receptacle outlet 221b. As the valve handle 254 is rotated, the fluid opening 251d begins to overlap the receptacle opening adjacent to the receptacle outlet 221b, so that fluid may begin to flow through the receptacle outlet 221b into the duct. Thus, the flow control mechanism 250 acts in the manner of a stopcock.

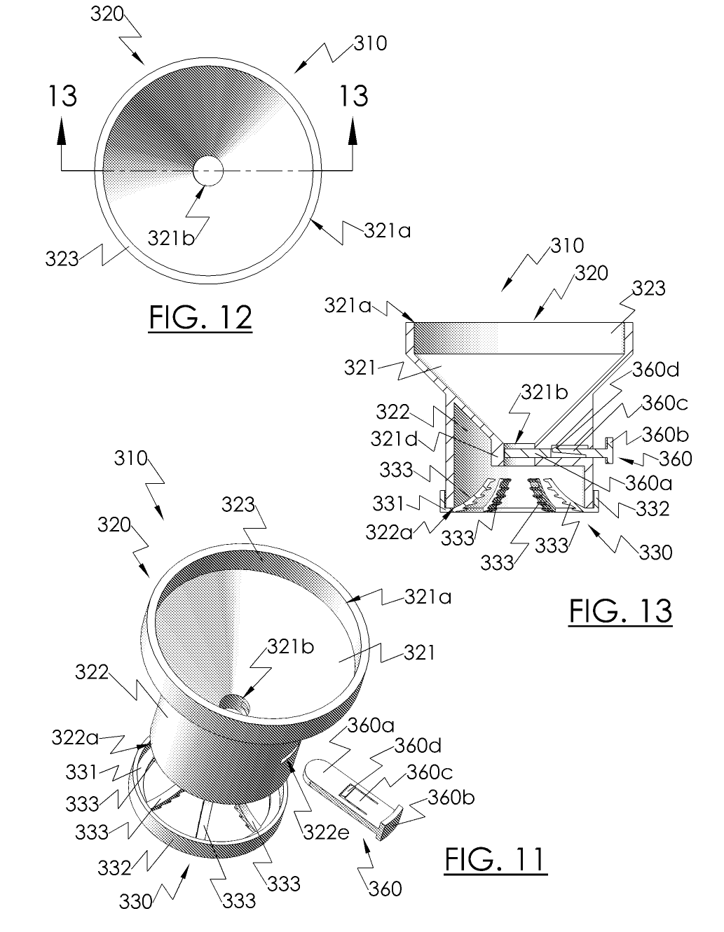

The device 310 illustrated in FIG. 11 through FIG. 13 discloses another embodiment of flow control means. In this embodiment, the device 310 is comprised of fluid directing means (fluid directing mechanism 320, which is further comprised of receptacle 321, further comprising a rim 323, and shell member 322 in this embodiment), flow control means (flow control mechanism 350 in this embodiment), and duct support means (duct support assembly 330 in this embodiment). Except as specifically noted below, the fluid directing means (receptacle 321, 323 and shell member 322) of the device 310 may comprise substantially any of the same structure, features, characteristics, functions and operation as the fluid directing means (receptacle 21, 121 and shell member 22, 122) described in more detail above and illustrated in connection with FIG. 1 through FIG. 7. In addition, and except as specifically noted below, the duct support means (duct support assembly 330) of the device 310 may comprise substantially any of the same structure, features, characteristics, functions and operation as the duct support means (duct support assembly 30, 130) described in more detail above and illustrated in connection with FIG. 1 through FIG. 7.

In the device 310 illustrated in FIG. 11 through FIG. 13, the fluid directing means (fluid directing mechanism 320, which is further comprised of receptacle 321, 323 and shell member 322 in this embodiment) further comprise a valve extension member 321d that extends from around the receptacle outlet 321b to the shell member 322. A shell opening 322e extends from the exterior surface 322b of the shell member 322 into the valve extension member 321d through the receptacle 321 adjacent to the receptacle outlet 321b. The flow control means (flow control mechanism 360 in this embodiment) is comprised of a valve plate 360a, a valve handle 360b positioned at one end of the valve plate 360a, a valve tab portion 360c positioned within the valve plate 360a, and a valve ridge 360d positioned at one end of the valve tab portion 360c. The valve plate 360a is positioned within and extends into the shell opening 322e. In order to insert the valve plate 360a into the shell opening 322e, the user of the device 310 depresses the distal end of the valve tab portion 360c down into the valve plate 360a (or the valve tab portion 360c may be so depressed by friction as the valve plate 360a is inserted into the shell opening 322e), so that the valve ridge 360d is deflected down into the valve plate 360a enough to allow the valve plate 360a to enter the shell opening 322e. The valve ridge 360d then engages a larger portion of the shell opening 322e, which enables the distal end of the valve plate 360a to travel into the shell opening 322e the entire length of the shell opening 322e without interference. When the valve plate 360a travels in the opposite direction (out of the shell opening 322e), the valve ridge 360d abuts against a portion of the interior surface of the shell member 322 adjacent to the shell opening 322e, limiting the travel of the valve plate 360a and holding the valve plate 360a operatively in place relative to the shell member 322. The user of the device 310 may, however, depress the valve tab portion 360c once again so that the valve ridge 360d clears the adjoining portion of the shell member 322, allowing the valve plate 360a to be removed from the shell member 322 entirely. This may be desirable for cleaning of the device 310. When the valve plate 360a is inserted all of the way into the shell opening 322e, the valve plate 360a blocks the receptacle outlet 321b so that no fluid flows through the receptacle outlet 321b into the duct (not illustrated). When the valve plate 360a is moved to intermediate positions relative to the receptacle outlet 321b, the rate of fluid flow through the receptacle outlet 321b into the duct may be regulated. Preferably, the configurations of the valve mechanism 360 and the shell member 322 (including the shell opening 322e) are designed so that travel of the valve plate 360a is limited somewhat by friction. Thus, when the user of the device 310 is not exerting pressure on the valve plate 360a, the valve plate 360a retains its position relative to the shell member 322 under anticipated operating conditions. The same configuration also preferably forms a seal between the valve plate 360a and the shell member 322, preventing the leakage of fluid through the space between the valve plate 360a and the shell member 322. Thus, the flow control mechanism 360 acts in the manner of a sliding valve.

It is to be noted that the flow control means and flow control mechanisms are not limited to the flow control means 250, 360 described in detail above and illustrated in FIG. 8 through FIG. 13. Instead, the flow control means and the flow control mechanism may comprise any suitable means for regulating the flow of fluids through ducts and apertures currently known in the relevant art or that may be developed in the relevant art in the future. For example, the flow control means and flow control mechanisms 250, 360 may comprise a check-valve, gate valve, ball valve, pressure regulator, backflow prevention device, needle valve, or a combination of such devices. In other embodiments, the flow control means and flow control mechanisms 250, 360 may be comprised of an orifice mechanism. The flow control means and flow control mechanisms 250, 360 may be used to regulate the flow, or to completely stop the flow, of fluids through the device 210, 310 when and as desired. This feature may enhance operation of the device 210, 310 by allowing the user of the device 210, 310 to determine how much fluid to transfer into the duct and to prevent overflow of the duct that may result in spillage of the fluid. As is the case with the device 610 illustrated in FIG. 20 through FIG. 22, it may also allow for returning some of the fluid from the receptacle 621, 623 back into the container (duct 640) from which the fluid was originally transferred.

Another embodiment of the present invention is represented by the device 410 illustrated in FIG. 14 through FIG. 17. In this embodiment, the device 410 is comprised of fluid directing means (fluid directing mechanism 420, which is further comprised of receptacle 421 and shell member 422 in this embodiment), internal fluid directing means (internal receptacle 470 in this embodiment), duct support means (duct support assembly 430 in this embodiment), and support assembly connecting means. Except as specifically noted below, the fluid directing means (fluid directing mechanism 420) of the device 410 may comprise substantially any of the same structure, features, characteristics, functions and operation as the fluid directing means (receptacles 21, 121 and shell members 22, 122) described in more detail above and illustrated in connection with FIG. 1 through FIG. 7. In addition, and except as specifically noted below, the duct support means (duct support assembly 430) of the device 410 may comprise substantially any of the same structure, features, characteristics, functions and operation as the duct support means (duct support assemblies 30, 130) described in more detail above and illustrated in connection with FIG. 1 through FIG. 7. Further, and except as specifically noted below, the support assembly connecting means of the device 410 may comprise substantially any of the same structure, features, characteristics, functions and operation as the support assembly connecting means described in more detail above and illustrated in connection with FIG. 1 through FIG. 7.

In the device 410 illustrated in FIG. 14 through FIG. 17, the receptacle 421 is hollow and has a receptacle inlet 421a that is larger than the receptacle outlet 421b. The device 410 further comprises an interior receptacle 470 having an interior receptacle outlet 471b, which is adapted to be positioned within the receptacle 421 so that the interior receptacle outlet 471b is approximately adjacent to the receptacle outlet 421b. A purpose of the interior receptacle 470 is to permit the device 410 to transfer fluids from a container (not illustrated) into ducts (such as spout 441) that are smaller than the receptacle outlet 421b, so that fluid is not spilled from the device 410. For example, in a modularized system, as is the case with the device 110 described in more detail above and illustrated in connection with FIG. 5 through FIG. 7, rather than utilizing a second fluid directing means (secondary receptacle 135 and secondary shell member 134) that are a part of the duct support assembly 130, it may be possible at the discretion of the user to utilize an interior receptacle 470 to accommodate transfer of fluid through the device 410 into smaller ducts (such as spout 441). Except as may be required to accommodate cooperation with the fluid directing means (receptacle 421 and shell member 422), the interior receptacle 470 of the device 410 may comprise substantially any of the same structure, features, characteristics, functions and operation as the fluid directing means (receptacle 21, 121 and shell member 22, 122) described in more detail above and illustrated in connection with FIG. 1 through FIG. 7. In the illustrated embodiment of the device 410, the interior receptacle 470 is also comprised of an outlet extension 471′, which may have substantially any of the same structure, features, characteristics, functions and operation as the outlet extension 21′ described in more detail above and illustrated in connection with FIG. 1 through FIG. 4. Preferably, the interior receptacle 470 has an outlet extension 471′, but it need not have an outlet extension 471′ in every embodiment.

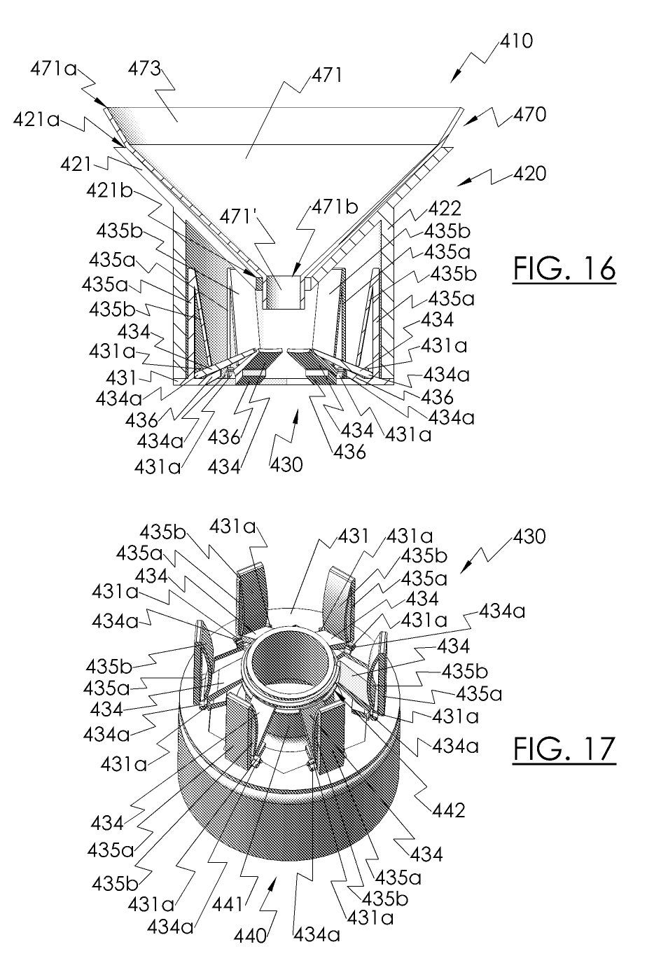

The device 410 illustrated in FIG. 14 through FIG. 17 also discloses another embodiment of duct support means, which are comprised of the duct support assembly 430 in this embodiment. This duct support assembly 430 is further comprised of a connecting member 431, a plurality of duct engaging members 434, and pivoting connecting means, which are described in more detail below, for pivotally connecting the duct engaging members 434 to the connecting member 431. The connecting member 431 operatively supports the duct engaging members 434 and permits the duct support assembly 430 to be operatively connected to the fluid directing means (receptacle 421 and shell member 422) utilizing the support assembly connecting means. Except as may be required to operatively cooperate with the duct engaging members 434 and the pivoting connecting means (described in more detail below), the connecting member 431 may comprise substantially any of the same structure, features, characteristics, functions and operation as the connecting member 31, 32 described in more detail above and illustrated in connection with FIG. 1 through FIG. 4. The duct engaging members 434 extend from the connector portion 431 “approximately toward” the longitudinal axis of the device 410. This means that they generally extend toward (but need not extend directly toward) the axis defined by a line extending through the centers of the receptacle outlet 421b and the open end of the duct (spout 441) while the duct (spout 441) is operatively held in place relative to the device 441, but that the duct engaging members 434 may also extend (but are not required to extend) longitudinally along such axis in either direction. For example, as illustrated in FIG. 14 and FIG. 16, the duct engaging members 434 extend inward toward the longitudinal axis of the device 410, but the distal ends of the duct engaging members 434 are also displaced somewhat toward the receptacle 421 as well. The duct engaging members 434 are adapted to engage the duct (spout 441), and may also engage threads 442 positioned on the duct (spout 441) while the duct (spout 441) is operatively connected to the device 410, as best illustrated in FIG. 17. In various embodiments, the duct engaging members 434 may have a greater or smaller width or thickness, may have a greater or lesser length, may not have a uniform width along their length, may have a different shape (e.g., all or a portion may be arcuate, as well as linear), or one or more of the duct engaging members 434 may have a different shape and orientation as compared to other duct engaging members 434, or any combination of the same. Although the duct engaging members 434 are preferably uniformly and symetrically spaced around the connecting member 431, the duct engaging members 434 may not be so spaced in other embodiments. Further, there are six duct engaging members 434 in this embodiment. In other embodiments, there may be more or fewer duct engaging members 434. Preferably, there are at least two duct engaging members 434 and no more than ten duct engaging members 434. The distal ends (the end adapted to engage the duct (spout 441)) of the duct engaging members 434 are also preferably arcuate in shape to assist the duct engaging members 434 in holding the duct (spout 441) in place by friction. The duct engaging members 434 are preferably constructed of a rigid or semi-rigid material, such as the materials that may be used to construct the duct support assembly 30 described in more detail above and illustrated in connection with FIG. 1 through FIG. 4, and may be fabricated using any of the same means.

In the device 410 illustrated in FIG. 14 through FIG. 17, pivoting connecting means are utilized for pivotally connecting the duct engaging members 434 to the connecting member 431. In the illustrated embodiment, the pivoting connecting means are comprised of a pin 434a that extends from each side of each engaging member 434 at one end thereof, a clamp 431a cooperating with each pin 434a, and a spring mechanism (described in more detail below) adapted to force a cooperating engaging member 434 against the duct (spout 441) while the duct (spout 441) is operatively held in place relative to the device 410. Preferably, each pin 434a is constructed from the same material as the engaging member 434 of which it is a part and is fabricated as a part of such engaging member 434. Alternatively, the pins 434a may be constructed of a different material or materials or may be connected to the engaging member 434 by any appropriate means, such as clasps, clamps, clips, pins, hinges, adhesives, adhesive tapes, epoxies, welding, fusing, nails, screws, nuts, bolts, or other types of fasteners or connectors, either alone or in conjunction with one another in different combinations. In the illustrated embodiment, each of the clamps 431a extends from the top surface of the connecting member 431 over a portion of its cooperating pin 434a. Thus, the pins 434a of each engaging member 434 may be placed adjacent to the open end of the corresponding clamps 431a, and then forced into the open end, causing the clamps 431a to spring open and then close after the pins are positioned within the clamps 431a. The clamps 431a then hold the duct engaging members 434 in place, but allow the duct engaging members 434 to pivot about the axis of the pins 434a. Also in this embodiment, the connecting member 431 is further comprised of support tabs 436 that extend from the interior edge of the connecting member 431. A purpose of the support tabs 436 is to support the duct engaging members 434 so that the duct engaging members 434 extend not only approximately toward the longitudinal axis of the device 410, but also back toward the receptacle 421 as well. This is the preferred position of the duct engaging members 434 because it typically makes the insertion of the duct (spout 441) into the device 410 easier, as opposed to duct engaging members 434 that extend more perpendicular to the longitudinal axis of the device 410. Preferably, each clamp 431a is constructed from the same material as the connecting member 431 and is fabricated as a part of the connecting member 431. Alternatively, the clamps 431a may be constructed of a different material or materials or may be connected to the connecting member 431 by any appropriate means, such as clasps, clamps, clips, pins, hinges, adhesives, adhesive tapes, epoxies, welding, fusing, nails, screws, nuts, bolts, or other types of fasteners or connectors, either alone or in conjunction with one another in different combinations. It is to be noted that any type of pivoting mechanism may be used as the pivoting connecting means. For example, the pivoting connecting means may be comprised of clasps, clamps, clips, pins, hinges, or other types of pivoting fasteners or connectors, either alone or in conjunction with one another in different combinations.

In the device 410 illustrated in FIG. 14 through FIG. 17, a spring mechanism 435a, 435b is adapted to force a cooperating engaging member 434 against the duct (spout 441) while the duct (spout 441) is operatively held in place relative to the device 410. In this embodiment, each spring mechanism 435a, 435b is comprised of a post portion 435a and a spring portion 435b. In the illustrated embodiment, each of the post portions 435a extends from the top surface of the connecting member 431 approximately adjacent to its cooperating engaging member 434. In various embodiments, the post portions 435a may have a greater or smaller width or thickness, may have a greater or lesser length, may not have a uniform width along their length, may have a different shape (e.g., all or a portion may be arcuate, as well as linear), or one or more of the post portions 435a may have a different shape and orientation as compared to other post portions 435a, or any combination of the same. Preferably, each post portion 435a is constructed from the same rigid or semi-rigid material as the connecting member 431 and is fabricated as a part of the connecting member 431. Alternatively, the post portion 435a may be constructed of a different material or materials or may be connected to the connecting member 431 by any appropriate means, such as clasps, clamps, clips, pins, hinges, adhesives, adhesive tapes, epoxies, welding, fusing, nails, screws, nuts, bolts, or other types of fasteners or connectors, either alone or in conjunction with one another in different combinations. The spring portion 435b is preferably constructed of a resilient material and extends from the post portion 435a to its cooperating engaging member 434. The orientation of the spring portion 435b is such that as the engaging member 434 is deflected longitudinally and radially outward to receive the duct (as the engaging member 434 pivots about the axis of the pin 434a), the spring portion 435b is deflected in a manner so that it exerts a force against the engaging member 434, which causes the engaging member 434 to exert a radially inward force against the duct (spout 441). When the duct (spout 441) is removed from the device 410, the spring portion 435b preferably forces the engaging member 434 to be returned to its position at rest, which the engaging member 434 had prior to engaging the duct (spout 441). In various embodiments, the spring portions 435b may have a greater or smaller width or thickness, may have a greater or lesser length, may not have a uniform width along their length, may extend from a different position on the post portion 435a, may have a different shape (e.g., may have a curvature in the opposite direction or all or a portion may be linear, as well as arcuate), or one or more of the spring portion 435b may have a different shape and orientation as compared to other spring portions 435b, or any combination of the same. Preferably, each spring portion 435b is constructed from the same rigid or semi-rigid material as its corresponding post portion 435a and is fabricated as a part of the post portion 435a. Alternatively, the spring portion 435b may be constructed of a different material or materials or may be connected to the post portion 435a by any appropriate means, such as clasps, clamps, clips, pins, hinges, adhesives, adhesive tapes, epoxies, welding, fusing, nails, screws, nuts, bolts, or other types of fasteners.

As is best illustrated by comparing the duct support assembly 430 of the device 410 of FIG. 14 and FIG. 16 with the duct support assembly 430 of FIG. 17 as it is connected to the duct (spout 441), the duct support means (and duct engaging members 434 in particular in this embodiment) are adapted to be deflected longitudinally and radially outward by the duct (spout 441) as the duct (spout 441) is operatively connected to the device 410. The duct support means (and duct engaging members 434 in particular in this embodiment) are “deflected longitudinally” in the sense that they are deflected in part approximately along the longitudinal axis of the device 410 generally toward the receptacle 421. The duct support means (and duct engaging members 434 in particular in this embodiment) are “deflected radially outward” in the sense that they are deflected in part radially away from the longitudinal axis of the duct (spout 441), as illustrated in FIG. 17. Thus, as the duct (spout 441) is operatively connected to the device 410, the duct (spout 441) is inserted into the device 410 so that the open end of the duct (spout 441) engages the duct engaging members 434. As the duct (spout 441) is advanced into the device 410, the duct (spout 441) causes the duct engaging members 434 to deflect longitudinally and radially outward as they pivot about the axis of their pins 434a. The spring portions 435b are also deflected by the duct engaging members 434 as the duct (spout 441) is operatively connected to the device 410. Once the duct (spout 441) is operatively in place in the device 410, which means that the duct (spout 441) is in the position relative to the receptacle desired by the user of the device 410 so that fluid may be transferred through the receptacle outlet 421b (and interior receptacle outlet 471b) into the duct (spout 441), the spring portions 435b exert a force against the duct engaging members 434, which causes the duct engaging members 434 to exert a force radially inward against the duct (spout 441). It is to be noted that the device 410 (and the duct support assembly 430 in particular) is capable of being operatively connected to ducts (spout 441) having a variety of different sizes and configurations (such as thread 442 designs) within a predetermined range, which gives the device 410 an advantage over other apparatus currently known in the relevant art.

When the user of the device 410 desires to remove the container 440 from the device 410, a force is exerted on the container 440 tending to pull the container 440 from the device 410 while the container 440 is rotated in a manner that causes the threads 442 to be disengaged from the duct engaging members 434 while the duct (spout 441) is displaced outward from the device 410 approximately along the longitudinal axis of the device 410. It is to be noted that the duct (spout 441) need not deflect the duct support means (duct support assembly 430) as the duct (spout 441) is operatively connected to the device 410 in all embodiments. For example, the support assembly 430 may have a mechanism (not illustrated) that allows the duct engaging members 434 to be deflected prior to insertion of the duct (spout 441) into the device 410, such as by a mechanism that allows the user of the device 410 to deflect the duct engaging members 434 independent of the position of the duct (spout 441). In this case, the duct engaging members 434 may be deflected first, the duct (spout 441) may then be inserted into the device 410, and the duct engaging members 434 may then be released to exert a radially inward force against the duct (spout 441) in order to hold the duct (spout 441) operatively in place relative to the device 410. In addition, it is to be noted that the duct support assembly 430 may be comprised of one or more duct engaging members 434 that do not pivot, but are instead fixed in position relative to the connecting member 434. For example, the duct support assembly 430 may comprise one fixed engaging member 434 that extends from the connecting member 431 and a second engaging member 434 that pivots as illustrated in FIG. 14 through FIG. 17. In this embodiment, the duct (spout 441) may cause the pivoting engaging member 434 to deflect, while the duct (spout 441) is braced against the non-pivoting engaging member 434. Further, it is to be noted that the duct support assembly 430 may comprise more than one type of duct support means. For example, the duct support assembly 430 may comprise one or more duct engaging members 434 and one or more duct engaging members 33, as described in more detail above and illustrated in FIG. 1 through FIG. 4, or one or more duct engaging members 534, as described in more below above and illustrated in FIG. 18 through FIG. 19, or any combination thereof.

Another embodiment of the present invention is the device 510 illustrated in FIGS. 18 and FIG. 19. In this embodiment, the device 510 is comprised of fluid directing means (fluid directing mechanism 520, which is further comprised of receptacle 521 and shell member 522 in this embodiment), duct support means (duct support assembly 530 in this embodiment), a securing cap 580 in this embodiment, and cap connecting means (described in more detail below) for operatively (and permanently or removably) connecting the securing cap 580 to the fluid directing means (and shell member 522 in this embodiment). Except as specifically noted below, the fluid directing means (fluid directing mechanism 520) of the device 510 may comprise substantially any of the same structure, features, characteristics, functions and operation as the fluid directing means (receptacles 21, 121 and shell members 22, 122) described in more detail above and illustrated in connection with FIG. 1 through FIG. 7. In addition, and except as specifically noted below, the duct support means (duct support assembly 530) of the device 510 may comprise substantially any of the same structure, features, characteristics, functions and operation as the duct support means (duct support assemblies 30, 130, 430) described in more detail above and illustrated in connection with FIG. 1 through FIG. 7 and FIG. 14 through FIG. 17. Further, and except as specifically noted below, the cap connecting means of the device 510 may comprise substantially any of the same structure, features, characteristics, functions and operation as the support assembly connecting means described in more detail above and illustrated in connection with FIG. 1 through FIG. 7. Further still, in various embodiments, the device 510 may further comprise flow control means.

In the device 510 illustrated in FIG. 18 and FIG. 19, the duct support assembly 530 is further comprised of a connecting member 531, a portion of which is positioned between the distal end 522a of the shell member 522 and a portion 581 of the securing cap 850. The sidewall portion 582 of the securing cap 580 has threads 582a on its interior surface that cooperate with threads 522c present on the exterior surface 522b of the shell member 522. Thus, the cap connecting means are comprised of the cooperating threads 532a, 522c, which allow the securing cap 580 to be removably connected to the shell member 522 by screwing the securing cap 580 onto the shell member 522 at its distal end 522a. While the securing cap 580 is operatively connected to the shell member 522, the duct support assembly 530 is held in place between the distal end 522a of the shell member 522 and a portion 581 of the securing cap 580. The securing cap 580 may be removed from the shell member 522 by unscrewing the securing cap 580 from the shell member 522. This feature allows the user of the device 510 to use various fluid directing means (receptacle 521 and shell member 522) interchangeably with various duct support means (duct support assembly 530). For example, if the connecting member 231 of the duct support assembly 230 illustrated in FIG. 8 through FIG. 10 and the connecting member 431 of the duct support assembly 430 illustrated in FIG. 14 through FIG. 17 were to have the same exterior dimension as the connecting member 531 of the duct support assembly 530 illustrated in FIG. 18 and FIG. 19, these other duct support assemblies 230, 430 would be interchangeable with the duct support assembly 530 of device 110, so that the user of device 510 could connect the shell member 522 to any of such duct support assemblies 230, 430, 530. Thus, this device 510 represents yet another type of modular system that permits the user of the device 510 to quickly and easily adapt the device 510 to accommodate different types of duct support means and size ranges of ducts (not illustrated) that may be operatively connected to the device 510 by interchanging different types and sizes of duct support assemblies 230, 430, 530. Substantially any type of fluid directing means, duct support means, and removable cap connecting means may be utilized in this type of modular system. The present invention also includes a method of using a modular system of this type. This method comprises: (a) either positioning the duct support means adjacent to the shell member, or positioning the duct support means adjacent to the securing cap; and (b) connecting the securing cap to the shell member using the cap connecting means.

Another embodiment of duct support means is also disclosed in the device 510 illustrated in FIG. 18 and FIG. 19. This duct support assembly 530 is further comprised of a connecting member 531, a plurality of duct engaging members 534, and pivoting connecting means, which are described in more detail below, for pivotally connecting the duct engaging members 534 to the connecting member 531. In various embodiments, the connecting member 531 and the duct engaging members 534 may comprise substantially any of the same structure, features, characteristics, functions and operation as the connecting member 431 and the duct engaging members 434, respectively, described in more detail above and illustrated in connection with FIG. 14 through FIG. 17. In addition, except as required to accommodate the different type of spring mechanism described below, the pivoting connecting means of the device 510 may comprise substantially any of the same structure, features, characteristics, functions and operation as the pivoting connecting means of the device 410 described in more detail above and illustrated in connection with FIG. 14 through FIG. 17. In the device 510 illustrated in FIG. 18 and FIG. 19, the pivoting connecting means comprise a spring mechanism 537, which is adapted to force a cooperating engaging member 534 against the duct (not illustrated). In this embodiment, each spring mechanism 537 is comprised of a coil spring 537 with two extending portions. One extending portion is attached to the duct engaging member 534 and the other is attached to the post member 535. In various embodiments, the coil springs 537 may have a greater or smaller size, may be positioned in a different orientation relative to the duct engaging member 534 and the post member 535, may have a different shape (e.g., may be a longer coiled spring that extends along its axis between the duct engaging member 534 and the post member 535), or one or more of the coil springs 537 may have a different shape and orientation as compared to other coil springs 537, or any combination of the same. The coil springs 537 may be constructed of any suitable resilient material, such as materials that may be used to construct the duct support assembly 30, as described in more detail above and illustrated in connection with FIG. 1 through FIG. 4. Preferably, each coil spring 537 is constructed from spring steel. The coil spring 537 may be connected to the duct engaging member 534 and the post member 535 by any appropriate means, such as clasps, clamps, clips, pins, hinges, adhesives, adhesive tapes, epoxies, welding, fusing, nails, screws, nuts, bolts, or other types of fasteners or connectors, either alone or in conjunction with one another in different combinations. The orientation of the coil spring 537 is such that as the duct engaging member 534 is deflected longitudinally and radially outward to receive the duct (as the duct engaging member 534 pivots about the axis of the pin 534a), the coil spring 537 is deflected in a manner so that it exerts a force against the duct engaging member 534, which causes the duct engaging member 534 to exert a radially inward force against the duct. When the duct is removed from the device 510, the coil spring 537 preferably forces the duct engaging member 534 to be returned to its position at rest, which the duct engaging member 534 had prior to engaging the duct. Thus, except for the difference in the type of spring mechanism 537 utilized, the operation of the duct support assembly 530 is substantially the same as the duct support assembly 430 of the device 410 illustrated in FIG. 14 through FIG. 17.

Another embodiment of the present invention is the device 610 illustrated in FIG. 20 through FIG. 22. In this embodiment, the device 610 is comprised of fluid directing means (fluid directing mechanism 620, which is further comprised of receptacle 621, 623 and shell member 622 in this embodiment), flow control means (flow control mechanism 650 in this embodiment), and duct support means (duct support assembly 630 in this embodiment). Except as noted below, the fluid directing means (fluid directing mechanism 620) of the device 610 may comprise substantially any of the same structure, features, characteristics, functions and operation as the fluid directing means 20, 120 (receptacles 21, 121 and shell members 22, 122) described in more detail above and illustrated in connection with FIG. 1 through FIG. 7. In addition, and except as noted below, the duct support means (duct support assembly 630) of the device 610 may comprise substantially any of the same structure, features, characteristics, functions and operation as the duct support means (duct support assemblies 30, 130, 430) described in more detail above and illustrated in connection with FIG. 1 through FIG. 7 and FIG. 14 through FIG. 17. Further, and except as noted below, the flow control means (flow control mechanism 650) of the device 610 may comprise substantially any of the same structure, features, characteristics, functions and operation as the flow control means (flow control mechanisms 250, 360) described in more detail above and illustrated in connection with FIG. 8 through FIG. 13. In some embodiments, the device 610 may further comprise support assembly connecting means (described in more detail below) for operatively (and permanently or removably) connecting the fluid directing means (fluid directing mechanism 620 and shell member 622 in particular in this embodiment) to the duct support means (duct support assembly 630 in this embodiment). In such embodiments, and except as noted below, the support assembly connecting means of the device 610 may comprise substantially any of the same structure, features, characteristics, functions and operation as the support assembly connecting means described in more detail above and illustrated in connection with FIG. 1 through FIG. 7.

In the device 610 illustrated in FIG. 20 through FIG. 22, which is adapted to be connected to a duct (not illustrated), the receptacle 621, 623 further comprises a receptacle inlet 621a that is adapted to be operatively connected to a second duct (pipe 640), so that fluid (not illustrated) is adapted to be transferred from the second duct (pipe 640) through the receptacle inlet 621a into the receptacle 621, 623. In this embodiment, the receptacle 621, 623 has a chamber formed by a funnel-type portion 621 and a covering portion 623. Also in this embodiment, the portion of the receptacle 621, 623 adjacent to the receptacle inlet 621a is cylindrical in shape and has threads 623a on its interior surface. These threads 623a cooperate with threads 642 on the exterior surface of the second duct (pipe 640) so that the second duct (pipe 640) may be operatively connected to the receptacle 621, 623 by rotating the second duct (pipe 640) into the receptacle inlet 621 as the threads 623a, 642 engage one another. Once the second duct (pipe 640) is operatively connected to the receptacle 621, 623, fluid may flow from the second duct (pipe 640) into the chamber formed by the receptacle 621, 623 and then through the receptacle outlet 621b into the duct. The flow control mechanism 650 may be used to stop and regulate the flow of fluid from the receptacle 621, 623 chamber through the receptacle outlet 621b into the duct. Thus, the device 610 permits the receptacle 621, 623 to be directly connected to the source of the fluid that is to be transferred to the duct by the device 610. The receptacle 621, 623 and the shell member 622 are preferably constructed from a rigid or semi-rigid material, which may generally include any of the materials used to comprise the fluid directing means (fluid directing mechanism 20) described above and illustrated in connection with FIG. 1 through FIG. 4. More preferred, the funnel-type portion 621, the covering portion 623, and the shell member 622 are constructed of the same material, but they need not be so constructed in every embodiment. The funnel-type portion 621, the covering portion 623, and the shell member 622 may be constructed together as a single unit, or one or more of them may be constructed separately, in which case they may be operatively connected together using any suitable means, such as a threaded connection, clasps, clamps, clips, pins, hinges, adhesives, adhesive tapes, epoxies, welding, fusing, nails, screws, nuts, bolts, or other types of fasteners or a combination of the same. In a preferred embodiment, the funnel-type portion 621 and the shell member 622 may be constructed together as a single unit, and the covering portion 623 may be removably connected to the funnel-type portion 621 by a threaded connection. In this embodiment, the user of the device 610 has the flexibility to use the device 610 as a funnel without the covering portion 623 when desired, and to then use the device 610 to obtain a rigid connection to the second duct (pipe 640) by removably connecting the covering portion 623 to the funnel-type portion 621 by means of the threaded connection. The funnel-type portion 621, the covering portion 623, and the shell member 622 may be constructed using any suitable means, such as injection molding if constructed of a polymer material.

It is to be noted that the device 610 may take almost any shape that permits an operative connection with the second duct (pipe 640) and cooperation with the remaining components comprising the device 610. For example, the receptacle 621, 623 may be approximately elliptical, triangular, square, rectangular, pentagonal, another polygonal shape, other shapes having arcuate or linear portions, or another shape or combination of such shapes when viewed from almost any perspective. In addition, in various embodiments, the receptacle inlet 621a may have a different orientation relative to the receptacle 621, 623. For example, the receptacle inlet 621a may be positioned perpendicular to the longitudinal axis of the device 610, or it may extend from a different position on the receptacle 621, 623. Further, in other embodiments, the operative connection with the second duct (pipe 640) may be comprised of almost any means that may be used for making a connection with ducts. For example, the operative connection may be comprised of a male iron pipe (MIP) adapter. As other examples, the operative connection may be comprised of welding, fusing, adhesives, glues, epoxies, a garden hose connector, a connector having any thread types (male or female), luer or luer lock fittings, SWAGELOK® fittings, quick connect/disconnect fittings, hose barbs, stepped tubing connectors, bushings, flanges, compression fittings, tubing and hose connectors, SPEEDFIT® connectors, couplings for connection using clamps or adhesives, variable connecting means for connecting to ducts of various sizes and shapes, or other means or a combination of such means. In addition, the operative connection may be comprised in whole or in part of a segment of conduit, tubing (including medical or food grade tubing), pipeline, duct, hose, channel, vent, a spout or other outlet or inlet member, or other similar objects or a combination of such objects extending from a portion of the receptacle 621, 623. The preferred operative connection for use with any particular embodiment of the device 610 depends upon a number of factors, such as the anticipated material composition and size or range of sizes of the second duct (pipe 640), the anticipated operating pressures of the device 610 (i.e., the pressures expected in the receptacle 621, 623 chamber), the anticipated operating temperatures of the device 610, the materials comprising and the shape and size of the receptacle 621, 623, the preferences of the user of the device 610, and other factors.

Another embodiment of the present invention is the device 810 illustrated in FIG. 23 and FIG. 24. In this embodiment, the device 810 is comprised of fluid directing means (fluid directing mechanism 811, which is comprised solely of receptacle 811 in this embodiment) and duct support means (support assembly 812, 813, which is comprised of a plurality of duct support members 812, 813 extending from the receptacle 811 in this embodiment). The receptacle 811 has a receptacle outlet 811b, and in various embodiments may comprise substantially any of the same structure, features, characteristics, functions and operation as the receptacles 21, 121 described in more detail above and illustrated in connection with FIG. 1 through FIG. 7. The receptacle 811 is adapted to receive a fluid (not illustrated) and direct it through the receptacle outlet 811b into a duct (not illustrated) comprising a duct open end adapted to receive the fluid. The duct support members 812, 813 extend from the receptacle 811 and are adapted to operatively hold the duct in place relative to the receptacle 811. As described in more detail below, the duct support members 812, 813 are adapted to deflect longitudinally and radially outward from the duct and exert a radially inward force against the duct.

In the device 810 illustrated in FIG. 23 and FIG. 24, the duct support means are comprised of a duct support assembly 812, 813, which is further comprised of a plurality of duct support members 812, 813. In this embodiment, each of the duct support members 812, 813 is further comprised of a connector portion 812 and an engaging portion 813. Also in this embodiment, the connector portions 812 extend approximately longitudinally from the receptacle 811. By extending “approximately longitudinally” from the receptacle 811, it is meant that connector portions 812 are generally parallel to the longitudinal axis of the device 810, but that the connector portions 812 may deviate from being parallel as long as the deviation does not materially adversely affect operation of the device 810. The longitudinal axis of the device 810 is generally defined by a line passing through the center of the receptacle outlet 811b and the center of the open end of the duct while the duct is operatively connected to the device 810. Thus, the connector portions 812 generally extend parallel to the longitudinal axis of the device 810 in this embodiment. In this embodiment, one end of the connector portions 812 has a shape and orientation that enables it to be operatively connected to the receptacle 811 using support assembly connecting means, as described in more detail below. Although this is the preferred orientation in this embodiment, the orientation of one or more of the connector portions 812 relative to the receptacle 811 may be different in other embodiments. In the device 810, the connector portions 812 have the shape illustrated. In other embodiments, one or more of the connector portions 812 may have a different shape. For example, the connector portions 812 may be approximately elliptical, triangular, square, rectangular, pentagonal, another polygonal shape, other shapes having arcuate or linear portions, or another shape or combination of such shapes, when viewed from almost any perspective, as long as the connector portions 812 cooperate with the receptacle 811 in operation of the device 810 and adequately perform their function of operatively supporting the engaging portions 813 in a manner that permits the engaging portions 813 to perform their intended function, as described in more detail below. The connector portions 812 are preferably constructed from a rigid or semi-rigid material, which may generally include any of the materials used to comprise the fluid directing means (fluid directing mechanism 20) described above and illustrated in connection with FIG. 1 through FIG. 4.

In this embodiment, the engaging portions 813 extend in an arc from their supporting connector portions 812 toward the longitudinal axis of the device 810 and toward the receptacle 811, as illustrated in FIG. 23 and FIG. 24. (As described above, the longitudinal axis of the device 810 is generally defined by a line passing through the center of the receptacle outlet 811b and the center of the open end of the duct while the duct is operatively connected to the device 810.) It is to be noted that by “extend toward the longitudinal axis of the device 810,” the engaging portions 813 extend in the general direction of, and not necessarily directly toward, the longitudinal axis of the device 810. In various embodiments, the engaging portions 813 of the device 810 may comprise substantially any of the same structure, features, characteristics, functions and operation as the duct engaging members 33 described in more detail above and illustrated in connection with FIG. 1 through FIG. 4. Thus, the arc formed by the engaging portions 813 may have a greater or smaller radius than illustrated in FIG. 23 and FIG. 24, the engaging portions 813 may have a greater or lesser length, the engaging portions 813 may not have a uniform width along their length, only a portion of the engaging portions 813 may be arcuate while part is linear, or one or more of the engaging portions 813 may have a different shape and orientation as compared to other engaging portions 813, or any combination of the same. In the illustrated embodiment, the engaging portions 813 extend from the distal end of the connector portions 812. In other embodiments, the engaging portions 813 may extend from any other portion of the connector portions 812 or even from the receptacle 811 (or both). Also in this embodiment, the engaging portions 813 further comprise a plurality of thread tab portions, which are not designated by identity numbers in FIG. 23 and FIG. 24, but which may comprise substantially any of the same structure, features, characteristics, functions and operation as the thread tab portions 33a described in more detail above and illustrated in connection with FIG. 1 through FIG. 4. Preferably, at least one of the engaging portions 813 comprises a plurality of thread tab portions. More preferred, each of the engaging portions 813 has a plurality of thread tab portions. The thread tab portions may be spaced uniformly along the engaging portions 813 and have the same shape, spacing, arrangement and orientation on all of the engaging portions 813. In other embodiments, one or more of the engaging portions 813 may not have any thread tab portions, may have fewer or more thread tab portions than other engaging portions 813, or may have a different shape, spacing, arrangement or orientation of thread tab portions than other engaging portions 813, or any combination thereof. In the illustrated embodiment, there are five thread tab portions on each engaging portions 813, but in other embodiments there may be fewer or more thread tab portions depending upon the anticipated use of the device 810 and the desires of the user of the device 810.

It is to be noted that the duct support means (duct support assembly 812, 813) of the device 810 may comprise substantially any of the same structure, features, characteristics, functions and operation as the duct support means (duct support assemblies 30, 130, 430, 530) described in more detail above and illustrated in connection with FIG. 1 through FIG. 7 and FIG. 14 through FIG. 19. In these embodiments, each engaging portion 813 preferably extends from one of a plurality of separate connector portions 812 that extend from the receptacle 811, rather than from a single connecting member that may be connected to a shell member. Using the duct support assembly 530 illustrated in FIG. 18 and FIG. 19 as an example, each of the duct support members may be comprised of a connector portion that is similar to the connector portion 812 of the device 810, and the engaging portion may be comprised of an engaging member 534 and its cooperating pivoting connecting means 534a, 531a, 535, 536, 537, which are all connected to the connector portion 812. Although the engaging portions 813 and connector portions 812 are preferably uniformly and symetrically spaced around the receptacle 811, the engaging portions 813 and connector portions 812 may not be so spaced in other embodiments. Further, there are six engaging portions 813 and connector portions 812 in this embodiment. In other embodiments, there may be more or fewer engaging portions 813 or connector portions 812 or both. Preferably, there are at least three duct support members 812, 813 and no more than ten duct support members 812, 813. The support assembly 812, 813 may be removably or permanently connected to the receptacle 811 by support assembly connecting means, which may comprise substantially any of the same structure, features, characteristics, functions and operation as the support assembly connecting means described in more detail above and illustrated in connection with FIG. 1 through FIG. 7. Preferably, the engaging portions 813 and connector portions 812 are constructed of the same material, but they need not be so constructed in every embodiment. The engaging portions 813 and connector portions 812 may be constructed together as a single unit, or they may be constructed separately, in which case they may be operatively connected together using any suitable means, such as a threaded connection, clasps, clamps, clips, pins, hinges, adhesives, adhesive tapes, epoxies, welding, fusing, nails, screws, nuts, bolts, or other types of fasteners. The engaging portions 813 and connector portions 812 may be constructed using any suitable means, such as injection molding if constructed of a polymer material.

Another embodiment of the present invention is the device 910 illustrated in FIG. 25 through FIG. 27. In this embodiment, the device 910 is comprised of fluid directing means (fluid directing mechanism 911, which is comprised solely of receptacle 911 in this embodiment) and duct support means (support assembly 912, 913, which is comprised of a plurality of duct support members 912, 913 extending from the receptacle 911 in this embodiment). The receptacle 911 has a receptacle outlet 911b and in various embodiments, may comprise substantially any of the same structure, features, characteristics, functions and operation as the receptacles 21, 121 described in more detail above and illustrated in connection with FIG. 1 through FIG. 7. The receptacle 911 is adapted to receive a fluid (not illustrated) and direct it through the receptacle outlet 911b into a duct (spout 941 on container 940) comprising a duct open end 941a adapted to receive the fluid. The duct support members 912, 913 extend from the receptacle 911 and are adapted to be deflected radially outward from the duct (spout 941) and to operatively hold the duct in place relative to the receptacle 911 by exerting a radially inward force against the duct (spout 941).

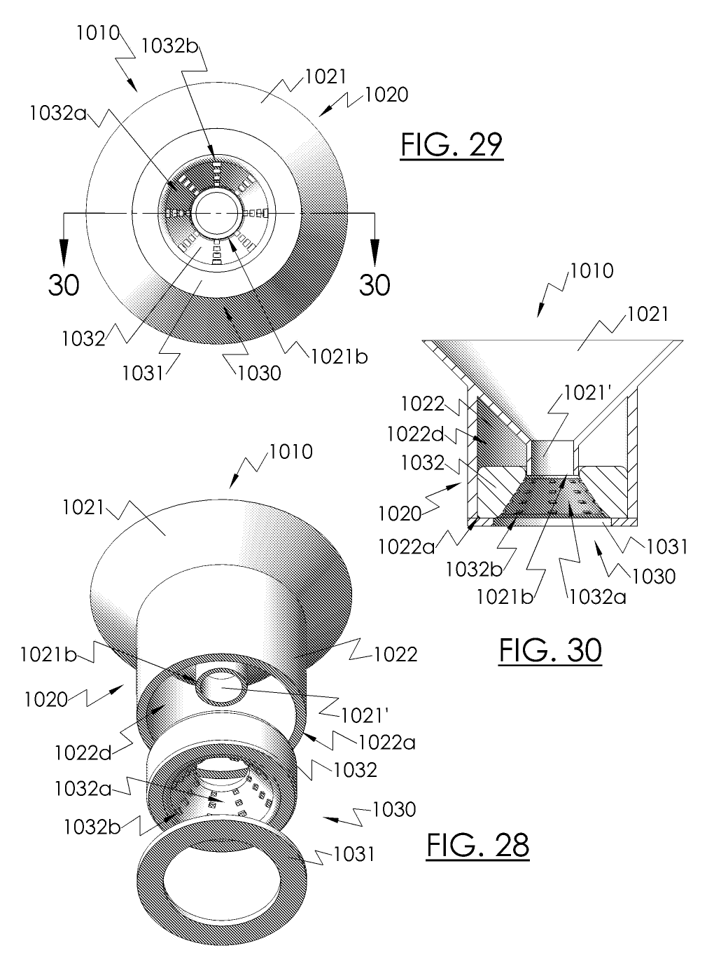

In the device 910 illustrated in FIG. 25 through FIG. 27, the duct support means are comprised of a duct support assembly 912, 913, which is further comprised of a plurality of duct support members 912, 913. In this embodiment, each of the duct support members 912, 913 is further comprised of a connector portion 912 and an engaging portion 913. Although the duct connector portions 912 have the shape and orientation (e.g., extending “approximately longitudinally” from the receptacle 911) illustrated in FIG. 25 and FIG. 26 in this embodiment, in other embodiments the duct connector portions 912 may comprise substantially any of the same structure, features, characteristics, functions and operation as the connector portions 812 described in more detail above and illustrated in connection with FIG. 23 and FIG. 24. Although the illustrated orientation of the connector portions 912 (e.g., extending “approximately longitudinally” from the receptacle 911, similar to the connector portion 812 described above and illustrated in connection with FIG. 23 and FIG. 24) is the preferred orientation in this embodiment, the orientation of one or more of the connector portions 912 relative to the receptacle 911 may be different in other embodiments. In this embodiment, each of the engaging portions 913 extends from its supporting connector portion 912 “approximately toward” the longitudinal axis of the device 910. This means that they generally extend toward (but need not extend directly toward) the axis defined by a line extending through the centers of the receptacle outlet 911b and the open end of the duct (spout 941) while the duct (spout 941) is operatively held in place relative to the device 910, but that the engaging portions 913 may also extend (but are not required to extend) longitudinally along such axis in either direction. For example, as illustrated in FIG. 25 through FIG. 27, the engaging portions 913 extend inward toward the longitudinal axis of the device 410, but the distal ends of the engaging portions 913 are also displaced somewhat toward the receptacle 911 as well. The engaging portions 913 are adapted to engage the duct (spout 941), and may also engage threads 942 positioned on the duct (spout 941), as best illustrated in FIG. 27. In various embodiments, the engaging portions 913 may have a greater or smaller width or thickness, may have a greater or lesser length, may not have a uniform width along their length, may have a different shape (e.g., all or a portion may be arcuate, as well as linear), or one or more of the engaging portions 913 may have a different shape and orientation as compared to other engaging portions 913, or any combination of the same. The distal ends (the end adapted to engage the duct (spout 941)) of the engaging portions 913 are preferably arcuate in shape to assist the engaging portions 913 in holding the duct (spout 941) in place by friction.

Although the duct support members 912, 913 are preferably uniformly and symetrically spaced around the receptacle 911, as illustrated in FIG. 25 through FIG. 27, the duct support members 912, 913 may not be so spaced in other embodiments. Further, there are ten duct support members 912, 913 in this embodiment. In other embodiments, there may be more or fewer duct support members 912, 913. Preferably, there are at least three duct support members 912, 913 and no more than ten duct support members 912, 913. The duct support members 912, 913 are preferably constructed of a rigid or semi-rigid material that is also resilient, such as the materials that may be used to construct the duct support assembly 30 described in more detail above and illustrated in connection with FIG. 1 through FIG. 4. The duct support assembly 912, 913 may be removably or permanently connected to the receptacle 911 by support assembly connecting means, which may comprise substantially any of the same structure, features, characteristics, functions and operation as the support assembly connecting means described in more detail above and illustrated in connection with FIG. 1 through FIG. 7. Preferably, the engaging portions 913 and connector portions 912 are constructed of the same material, but they need not be so constructed in every embodiment. The engaging portions 913 and connector portions 912 may be constructed together as a single unit, or they may be constructed separately, in which case they may be operatively connected together using any suitable means, such as a threaded connection, clasps, clamps, clips, pins, hinges, adhesives, adhesive tapes, epoxies, welding, fusing, nails, screws, nuts, bolts, or other types of fasteners. The engaging portions 913 and connector portions 912 may be constructed using any suitable means, such as injection molding if constructed of a polymer material.

In the device 910 illustrated in FIG. 25 through FIG. 27, the duct support means (duct support assembly 912, 913) are adapted to operatively hold the duct (spout 941) in place relative to the receptacle 911, as described in more detail below. In this embodiment, the duct support members 912, 913 are adapted to be deflected radially outward by the duct (spout 941) as the duct (spout 941) is operatively connected to the receptacle 911 and to exert a radially inward force against the duct (spout 941), all as described in more detail below. Thus, as best illustrated by comparing FIG. 26 with FIG. 27, the duct (spout 941) is inserted (and may also be rotated as it is inserted) into the duct support means (duct support members 912, 913) when the user of the device 910 desires to connect the container 940 to the device 910. As the duct (spout 941) is inserted into the device 910, the connector portions 912 of the duct support members 912, 913 may be (but need not always be) deflected radially outward by the duct (spout 941) as the duct (spout 941) is moved into position relative to the device 910. In addition, as the duct (spout 941) is inserted into the device 910, the engaging portions 913 of the duct support members 912, 913 are deflected radially outward, and may also be deflected longitudinally toward the receptacle 911, by the duct (spout 941) as the duct (spout 941) is moved into position relative to the device 910. As best illustrated in FIG. 27, the distal end of the engaging portions 913 may engage any threads 942 or other geometrical features that may be present on the duct (spout 941) to assist in operatively connecting the device 910 to the duct (spout 941). While the duct (spout 941) is held operatively in position relative to the device 910, the duct support members 912, 913 exert force radially inward against the duct (spout 941), operatively connecting the duct (spout 941) and the container 940 to the device 910. This is typically the case because the duct support members 912, 913 are preferably constructed of a resilient material. It is to be noted that in this embodiment any combination of connector portions 912 and engaging portions 913 may be deflected to accommodate connection of the duct (spout 941) to the device 910. For example, in various embodiments, the connector portions 912 may be adapted to deflect, while the engaging portions 913 may be rigid so that they do not deflect, or the opposite may be the case. Preferably, the duct open end is adapted to receive the fluid and the duct (spout 941) is adapted to have a variety of different sizes and configurations within a predetermined range. The duct support means (duct support members 912, 913) are adapted to operatively hold ducts (such as spout 941) having a size and configuration of duct open end within the predetermined range. When the user of the device 910 desires to remove the container 940 from the device 910, a force is exerted on the container 940 tending to pull the container 940 from the device 910 while the container 940 is rotated in a manner that causes the threads 942 to be disengaged from the engaging portions 913 while the duct (spout 941) is displaced outward from the device 910 approximately along the longitudinal axis of the device 910. It is to be noted that the duct (spout 941) need not deflect the duct support means (duct support members 912, 913) as the duct (spout 941) is operatively connected to the device 910 in all embodiments. For example, the duct support members 912, 913 may have a mechanism (not illustrated) that allows the duct support members 912, 913 to be deflected prior to insertion of the duct (spout 941) into the device 910, such as by a mechanism that allows the user of the device 910 to deflect the duct support members 912, 913 independent of the position of the duct (spout 941).

Another embodiment of the present invention is represented by the device 1010 illustrated in FIG. 28 through FIG. 30. In this embodiment, the device 1010 is comprised of fluid directing means (fluid directing mechanism 1020, which is further comprised of receptacle 1021 and shell member 1022 in this embodiment), duct support means (duct support assembly 1030 in this embodiment), and support assembly connecting means for removably or permanently connecting the duct support means (duct support assembly 1030) to the fluid directing means (receptacle 1021 and shell member 1022). Except as specifically noted below, the fluid directing means (receptacle 1021 and shell member 1022) of the device 1010 may comprise substantially any of the same structure, features, characteristics, functions and operation as the fluid directing means (fluid directing mechanisms 20, 120) described in more detail above and illustrated in connection with FIG. 1 through FIG. 7. In addition, and except as specifically noted below, the support assembly connecting means of the device 1010 may comprise substantially any of the same structure, features, characteristics, functions and operation as the support assembly connecting means described in more detail above and illustrated in connection with FIG. 1 through FIG. 7.

The device 1010 illustrated in FIG. 28 through FIG. 30 discloses another embodiment of duct support means, which are comprised of the duct support assembly 1030. The duct support assembly is further comprised of a support flange 1031, a compressible member 1032 comprising an interior surface 1032a, and a plurality of thread tab members 1032b, which are adapted to engage any threads or other geometrical features on a duct (not illustrated) to be connected to the device 1010. In the illustrated embodiment, the compressible member 1032 may be comprised of a hollow, inflatable bladder that contains a compressible fluid, such as air or nitrogen. In this case, the bladder may be constructed in whole or in part of rubber, synthetic rubber, another flexible polymer, cloth, fabric, or other flexible materials or a combination of such materials. Alternatively, the compressible member 1032 may be comprised in whole or in part of a resilient foam-type of material that compresses when pressure is exerted on its surface. For example, the compressible member 1032 may be comprised of polyurethane foam or another type of open cell foam material or a combination of such materials. Such foam material may also be positioned within a bladder. In yet other embodiments, the compressible member 1032 may be comprised of semi-flexible materials that have a structure allowing them to be compressed, while exerting a counter force against compression. For example, the compressible member 1032 may be comprised of a semi-flexible polymer, such as silicone, having a “honeycomb” pattern of voids within it, so that the compressible member 1032 may be compressed by the collapse of one or more of the voids. It is to be noted that many different combinations of materials and structures may be utilized in the compressible member 1032. In various embodiments, the compressible member 1032 may have a greater or smaller width or thickness, may not extend around the entire circumference of the shell member 1022, may not have a uniform width along its circumference, or may have a different shape or any combination of the same. Although there is preferably only one compressible member 1032, there may be more than one compressible member 1032 in other embodiments. Where there is more than one compressible member 1032, the compressible members 1032 may each have a different shape and orientation as compared to the other compressible members 1032.

In the device 1010 illustrated in FIG. 28 through FIG. 30, the thread tab members 1032b are adapted to engage any threads on a duct to be connected to the device 1010. The thread tab portions 1032b, which are not all designated by identity numbers in FIG. 28 through FIG. 30, may comprise substantially any of the same structure, features, characteristics, functions and operation as the thread tab portions 33a described in more detail above and illustrated in connection with FIG. 1 through FIG. 4. The thread tab portions 1032b, in embodiments where they are present, are preferably positioned on the interior surface 1032a of the compressible member 1032. In various embodiments, the thread tab portions 1032b may have different orientations and arrangements. In the device 1010, the compressible member 1032 is positioned within the interior space 1022d of the shell member 1022, with the external surface of the compressible member 1032 adjacent to the interior surface of the shell member 1022. Also in this embodiment, a surface of the compressible member 1032 is positioned adjacent to the support flange 1031, which is positioned adjacent to the distal end 122a of the shell member 1022. The compressible member 1032 may be connected to the interior surface of the shell member 1022 or the support flange 1031 or both. The support flange 1031 may have a variety of different shapes and characteristics, as long as it is able to perform its function of supporting the compressible member 1032 and being connected to the shell member 1022 using any of the support assembly connecting means. The support flange 1031 is preferably constructed of a rigid or semi-rigid material, such as the materials that may be used to construct the duct support assembly 30 described in more detail above and illustrated in connection with FIG. 1 through FIG. 4, and may be fabricated using any of the same means. In addition, the compressible member 1032 and the support flange 1031 preferably have modular characteristics that enable them to be interchangeable with other duct support assemblies 130, 530, as is the case with the devices 110, 510, respectively, described in more detail above and illustrated in connection with FIG. 5 through FIG. 7, FIG. 18, and FIG. 19.

In the embodiment of the device 1010 of FIG. 28 through FIG. 30, the duct support means (and compressible member 1032 in particular in this embodiment) are adapted to be deflected longitudinally and radially outward by the duct (not illustrated) as the duct is operatively connected to the device 1010. The duct support means (and compressible member 1032 in particular in this embodiment) are “deflected longitudinally” in the sense that compressible member 1032 is deflected in part approximately along the longitudinal axis of the device 410 generally toward the receptacle 1021 as the compressible member 1032 is compressed by the duct. The duct support means (and compressible member 1032 in particular in this embodiment) are “deflected radially outward” in the sense that at least a portion of the interior surface 1032a of the compressible member 1032 is deflected radially away from the longitudinal axis of the duct as the compressible member 1032 is compressed by the duct. Thus, as the duct is operatively connected to the device 1010, the duct is inserted into the device 1010 so that the open end of the duct engages the compressible member 1032. As the duct is advanced into the device 1010, the duct engages the interior surface 1032a of the compressible member 1032, compressing the compressible member 1032 so that the compressible member 1032 is deflected longitudinally and radially outward. Once the duct is operatively in place in the device 1010, which means that the duct is in the position relative to the receptacle 1021 desired by the user of the device 1010 so that fluids may be transferred through the receptacle outlet 1021b into the duct, the compressible member 1032 exerts a force radially inward against the duct. The thread tab members 1032b may also engage any threads present on the duct to assist in operatively holding the duct in place relative to the device 1010. It is to be noted that the device 1010 (and the duct support assembly 1030 in particular) is capable of being operatively connected to ducts having a variety of different sizes and configurations (such as thread designs) within a predetermined range, which gives the device 1010 an advantage over other apparatus currently known in the relevant art. When the user of the device 1010 desires to remove the duct from the device 1010, a force is exerted on the duct tending to pull the duct from the device 1010 while the duct is rotated in a manner that causes any threads on the duct to be disengaged from the thread tab members 1032b while the duct is displaced outward from the device 1010 approximately along the longitudinal axis of the device 1010.

It is to be noted that one or more of any of the aspects of each of the duct support means comprising any of the devices 10, 110, 210, 310, 410, 510, 610, 810, 910, 1010 described in more detail above and illustrated in connection with FIG. 1 through FIG. 30 and duct support assemblies 30, 130, 230, 330, 430, 530, 630, 812, 813, 912, 913, 1030 may be used in combination with any other aspects of any of such duct support means or duct support assemblies, or in combination with on or more aspects of any of the fluid directing means comprising any of the devices 10, 110, 210, 310, 410, 510, 610, 810, 910, 1010 described in more detail above and illustrated in connection with FIG. 1 through FIG. 30 and fluid directing mechanisms 20, 120, 220, 320, 420, 520, 620, 811, 911, 1020), or any combination thereof. Similarly, any aspects of any of the fluid directing means comprising any of the devices 10, 110, 210, 310, 410, 510, 610, 810, 910, 1010 described in more detail above and illustrated in connection with FIG. 1 through FIG. 30 and any aspects of any of fluid directing mechanisms 20, 120, 220, 320, 420, 520, 620, 811, 911, 1020 may be used interchangeably and in conjunction with any flow control mechanism (such as flow control mechanisms 250, 360) described in more detail above and illustrated in FIG. 8 through FIG. 13 or in conjunction with an interior receptacle (such as interior receptacle 470 described in more detail above and illustrated in FIG. 14 through FIG. 16), or any combination thereof. Further, it is to be noted that the present invention includes certain kits, which kits may be comprised of any combination of any of the duct support means (and duct support assemblies 30, 130, 230, 330, 430, 530, 630, 812, 813, 912, 913, 1030) with any of the fluid directing means (and fluid directing mechanisms 20, 120, 220, 320, 420, 520, 620, 811, 911, 1020) or with any of the devices 10, 110, 210, 310, 410, 510, 610, 810, 910, 1010, as all are described in more detail above and illustrated in connection with FIG. 1 through FIG. 30, or any combination thereof. Further still, it is to be noted that the present invention may comprise only the fluid directing means comprising any of the devices 10, 110, 210, 310, 410, 510, 610, 810, 910, 1010 or the fluid directing mechanism or mechanisms (such as fluid directing mechanisms 20, 120, 220, 320, 420, 520, 620, 811, 911, 1020), all as described in more detail above and illustrated in connection with FIG. 1 through FIG. 30. In addition, the present invention may comprise only the duct support means comprising any of the devices 10, 110, 210, 310, 410, 510, 610, 810, 910, 1010 or duct support assembly or assemblies (such as support assemblies 30, 130, 230, 330, 430, 530, 630, 812, 813, 912, 913, 1030), all as described in more detail above and illustrated in connection with FIG. 1 through FIG. 30.

As is apparent from the foregoing description, the preferred type of fluid directing means (such as fluid directing mechanisms 20, 120, 220, 320, 420, 520, 620, 811, 911, 1020), duct support means (such as support assemblies 30, 130, 230, 330, 430, 530, 630, 812, 813, 912, 913, 1030), flow control mechanism (such as flow control mechanisms 250, 360), if any, and support assembly connecting means, all as described in more detail above and illustrated in connection with FIG. 1 through FIG. 30, and combinations of the same, are dependent upon numerous different factors. A device 10, 110, 210, 310, 410, 510, 610, 810, 910, 1010 having a particular combination of features appropriate for one type of operating condition may not be appropriate for other types of operating conditions. Generally, a device designed for normal household kitchen use to transfer fluids at room temperature to standard types of kitchen containers may be constructed entirely of PVC and have the configuration of the device 810 described above and illustrated in connection with FIG. 23 and FIG. 24. Where more flexibility is desired in terms of the range of container spouts that may be accommodated by the device in such circumstances, the fluid directing means (and the support assembly connecting means) may incorporate a modular aspect, such as the form of the fluid directing member 520 (comprising receptacle 521 and shell member 522) and securing cap 580 described above and illustrated in connection with FIG. 18 and FIG. 19, all of which may be constructed of PVC. In this case, the duct support means preferably comprise several interchangeable duct support assemblies that take the form of duct support assembly 30 (but without the connecting sidewall portion 32) described above and illustrated in connection with FIG. 1 through FIG. 4, each of such duct support assemblies being constructed of PVC and adapted to connect to a different range of duct sizes and possibly configurations. Also in this case, an interchangeable fluid directing member incorporating flow control means (such as the sliding valve 630) may also be available for use interchangeably with the duct support assemblies 30 in instances where the user desires to control the flow of fluid through the device.

What is claimed is:

1. A device for transferring fluid into a duct, the device comprising a receptacle adapted to direct the fluid through a receptacle outlet into the duct, and duct support means for operatively holding the duct in place relative to the receptacle, wherein the duct support means are adapted to be deflected longitudinally and radially outward by the duct as the duct is operatively connected to the device and exert a radially inward force against the duct.

2. The device of claim 1, wherein the duct has a duct open end adapted to receive the fluid and to have a variety of different sizes and characteristics within a predetermined range, and the duct support means are adapted to operatively hold ducts having a size and characteristics within the predetermined range.

3. The device of claim 1, further comprising a shell member extending from the receptacle, wherein the duct support means are positioned adjacent to the shell member.

4. The device of claim 1, wherein the duct support means are comprised of a plurality of duct support members, and each of the duct support members is comprised of a connector portion extending approximately longitudinally away from the receptacle, and a duct engaging portion extending from the connector portion in the approximate direction of the longitudinal axis of the device.

5. The device of claim 4, wherein a portion of the duct engaging portion extends in an arc toward the longitudinal axis of the device and toward the receptacle.

6. A device for transferring fluid to a duct comprising a duct open end adapted to receive the fluid, the device comprising:
(a) a receptacle having a receptacle outlet, wherein the fluid is adapted to be directed through the receptacle outlet into the duct; and
(b) a plurality of duct support members extending from the receptacle and adapted to operatively hold the duct in place relative to the receptacle;
(c) wherein the duct support members are adapted to deflect radially outward from the duct and exert a radially inward force against the duct.

7. The device of claim 6, wherein each of the plurality of duct support members comprises:
(a) a connector portion extending away from the receptacle, and
(b) an engaging portion extending from the connector portion approximately toward the longitudinal axis of the device;
(c) wherein the connector portion is adapted to deflect radially outward from the duct.

8. The device of claim 7, wherein each of the engaging portions is comprised of a resilient material and a portion of the engaging portion extends from the connector portion in the approximate direction of the longitudinal axis of the device and toward the receptacle.

9. The device of claim 6, wherein each of the plurality of duct support members comprises:
(a) a connector portion extending away from the receptacle, and
(b) an engaging portion extending from the connector portion approximately toward the longitudinal axis of the device;
(c) wherein the engaging portion is adapted to deflect longitudinally and radially outward from the duct.

10. The device of claim 9, wherein each of the engaging portions is comprised of a resilient material and a portion of the engaging portion extends in an arc from the connector portion in the approximate direction of the longitudinal axis of the device and toward the receptacle.

11. The device of claim 10, wherein at least one of the engaging portions is further comprised of a thread tab portion.

12. The device of claim 9, further comprising pivoting connecting means for pivotally connecting the engaging portion to the connecting portion.

13. A device for transferring fluid into a duct, the device comprising:
(a) fluid directing means adapted to receive the fluid and direct the fluid into the duct, and
(b) a duct support assembly for operatively holding the duct in place relative to the fluid directing means;
(c) wherein a portion of the duct support assembly is adapted to be deflected radially outward by the duct and exert a radially inward force against the duct.

14. The device of claim 13, wherein the fluid directing means are further comprised of a funnel member.

15. The device of claim 14, wherein the fluid directing means are further comprised of a shell member extending from the funnel member, and the duct support assembly is positioned adjacent to the shell member.

16. The device of claim 15, further comprising support assembly connecting means for connecting the duct support assembly to the shell member.

17. The device of claim 13, further comprising material flow control means for regulating the flow of fluid from the fluid directing means into the duct.

18. A device for transferring a fluid to a duct having a duct open end adapted to receive the fluid, wherein the duct is adapted to have a variety of different sizes and characteristics within a predetermined range, the device comprising:
(a) a receptacle adapted to receive the fluid and direct the fluid through a receptacle outlet into the duct open end;
(b) a shell member extending from the receptacle;
(c) a duct support assembly positioned adjacent to the shell member and adapted to operatively connect the duct to the device;
(d) wherein the duct support assembly is adapted to exert a radially inward force against the duct for ducts having a size and characteristics within the predetermined range.

19. The device of claim 18, wherein the duct support assembly is further comprised of a connecting member positioned adjacent to the shell member and a plurality of duct engaging members extending from the connecting member.

20. The device of claim 19, wherein the plurality of duct engaging members extend in an arc from the connecting member toward the longitudinal axis of the shell member and toward the receptacle.

21. The device of claim 19, wherein the device further comprises pivoting connecting means for pivotally connecting the duct engaging members to the connecting member.

22. The device of claim 18, further comprising duct support assembly connecting means for permanently or removably connecting the duct support assembly to the shell member.

23. The device of claim 18, wherein the receptacle further comprises a receptacle inlet that is adapted to be operatively connected to a second duct, so that the fluid is adapted to be transferred from the second duct through the receptacle inlet into the receptacle.
